(19) United States
(12) Patent Application Publication
(10) Pub. No.: US 2021/0164859 A1
(43) Pub. Date: Jun. 3, 2021

(54) ANALYZING DEVICE, ANALYSIS METHOD, AND STORAGE MEDIUM

(71) Applicant: NEC Corporation, Tokyo (JP)

(72) Inventors: Shigeki SHINODA, Tokyo (JP); Hirofumi INOUE, Tokyo (JP); Takahiro KUMURA, Tokyo (JP); Katsumi KIKUCHI, Tokyo (JP)

(73) Assignee: NEC Corporation, Tokyo (JP)

(21) Appl. No.: 16/632,654

(22) PCT Filed: Jul. 23, 2018
(86) PCT No.: PCT/JP2018/027455

§ 371 Date: Jan. 21, 2020

(30) Foreign Application Priority Data
Jul. 26, 2017 (JP) 2017-144431

(51) Int. Cl. G01M 3/24; E03B 7/00; F17D 5/06

(52) U.S. Cl. CPC G01M 3/243; F17D 5/06; E03B 7/003

(57) ABSTRACT

Provided are an analyzing device and the like capable of suppressing erroneous determination. This analyzing device is provided with: a cross correlation calculating unit that obtains a cross correlation function with respect to vibrations detected at two points contained in a measurement sector of a pipeline; an estimating unit that estimates a cause of the vibrations, on the basis of the continuity of peaks in the cross correlation function; and an analyzing unit that analyzes the actual generation location of the vibrations and cause of the vibrations on the basis of an estimated generation location of the vibrations and cause of the vibrations and information relating to the configuration of a pipeline network.

### TECHNICAL FIELD

The present invention relates to an analyzing device, an analysis method, and a program.

### BACKGROUND ART

In the maintenance of pipelines, such as a water supply network, investigation of the occurrence or non-occurrence of leakage of fluid from a pipeline is performed. As a method for performing the investigation of the occurrence or non-occurrence of leakage, a method of determining the occurrence or non-occurrence of leakage and calculating a location at which the leakage has occurred based on cross-correlation function for a pair of vibration waveforms measured at a pair of points on a pipeline is used. Note that, in the present disclosure, the term “cross-correlation function” is sometimes used in the meaning of a “value that a cross-correlation function indicates”. In the present disclosure, the “cross-correlation function” is sometimes referred to as “cross correlation”.

In PTL 1, a leakage monitoring system and the like that, from measurement data from instruments installed in a plurality of water distribution blocks, estimate a leakage location speedily and easily are described.

### CITATION LIST

### Patent Literature

[PTL 1] International Publication No. WO 2008/029681

### SUMMARY OF INVENTION

### Technical Problem

In the above-described investigation on leakage, it is required to discriminate whether or not leakage has actually occurred or whether or not a vibration is a disturbance vibration that is generated by a cause other than leakage.

In addition, when the investigation on leakage is performed for a pipeline network in which a plurality of pipelines are connected and a vibration that may be associated with leakage on a specific pipeline is detected, it is required to take into consideration a possibility that the detected vibrations are generated on another pipeline that is connected to the pipeline on which detection is performed. That is, for the technology described in PTL 1, and the like, a technology for further preventing erroneous discrimination is expected to be developed.

The present invention has been made to solve the above-described problem, and a principal object of the present invention is to provide an analyzing device and the like that enable prevention of erroneous discrimination.

### Solution to Problem

An analyzing device of the present invention, as an aspect, includes:

cross correlation calculation means for calculating cross-correlation function between vibrations detected at a pair of points contained in a measurement sector of a pipeline;

estimation means for estimating a cause of the detected vibrations based on continuity of peaks in the cross-correlation function; and

analysis means for analyzing an actual generation location of the detected vibrations and an actual cause of the detected vibrations based on the estimated cause of the detected vibrations and information on a configuration of a pipeline network.

An analysis method of the present invention, as an aspect, includes:

calculating cross-correlation function between vibrations detected at a pair of points contained in a measurement sector of a pipeline;

estimating a cause of the detected vibrations based on continuity of peaks in the cross-correlation function; and

analyzing an actual generation location of the detected vibrations and an actual cause of the detected vibrations based on the estimated cause of the detected vibrations and information on a configuration of a pipeline network.

A computer-readable storage medium of the present invention, as an aspect, stores a program that causes a computer to perform:

calculating cross-correlation function between vibrations detected at a pair of points contained in a measurement sector of a pipeline;

estimating a cause of the detected vibrations based on continuity of peaks in the cross-correlation function; and

analyzing an actual generation location of the detected vibrations and an actual cause of the detected vibrations based on the estimated cause of the detected vibrations and information on a configuration of a pipeline network.

### Advantageous Effects of Invention

The present invention enables an analyzing device and the like that enable prevention of erroneous discrimination to be provided.

### BRIEF DESCRIPTION OF DRAWINGS

FIG. 1 is a diagram illustrating a configuration of an analyzing device in a first example embodiment of the present invention.

FIG. 2 is a diagram illustrating an example of a case where leakage of fluid from a pipeline is detected by means of a correlation-based leakage detection method.

FIG. 3 illustrates a case where, in detection of leakage by means of the correlation-based leakage detection method, a location different from an actual location is identified as a generation location of a vibration.

FIG. 4 illustrates another case where, in detection of leakage by means of the correlation-based leakage detection method, a location different from an actual location is identified as a generation location of a vibration.

FIG. 5 is a diagram illustrating a configuration when an analyzing device and measuring instruments in the first example embodiment of the present invention are connected.

FIG. 6 is a diagram illustrating an example of a case where an estimation unit of the analyzing device in the first example embodiment of the present invention estimates causes of vibrations.

FIG. 7 is a flowchart illustrating operation of the analyzing device in the first example embodiment of the present invention.

FIG. 8 is a diagram illustrating a configuration of an analyzing device in a second example embodiment of the present invention.

FIG. 9 is a diagram illustrating an example of a case where an estimation unit of the analyzing device in the second example embodiment of the present invention estimates a cause of a vibration.

FIG. 10 is a diagram illustrating another example of a case where the estimation unit of the analyzing device in the second example embodiment of the present invention estimates a cause of a vibration.

FIG. 11 is a flowchart illustrating operation of the analyzing device in the second example embodiment of the present invention.

FIG. 12 is a diagram illustrating a configuration of an analyzing device in a third example embodiment of the present invention.

FIG. 13 is a diagram illustrating an example of a case where an estimation unit of the analyzing device in the third example embodiment of the present invention estimates a cause of a vibration.

FIG. 14 is a flowchart illustrating operation of the analyzing device in the third example embodiment of the present invention.

FIG. 15 is a diagram illustrating an example of an information processing device achieving the analyzing devices in the respective example embodiments of the present invention.

### EXAMPLE EMBODIMENT

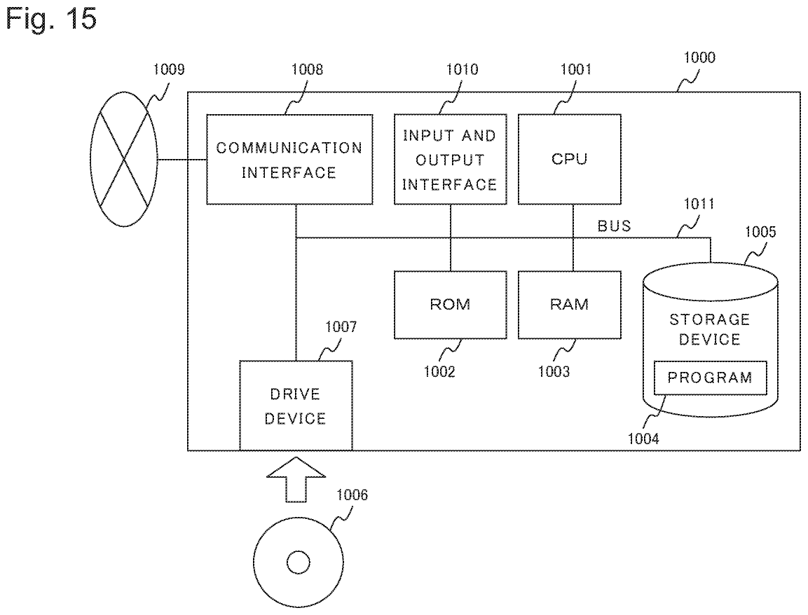

Respective example embodiments of the present invention will be described with reference to the accompanying drawings. In the respective example embodiments of the present invention, respective constituent components of respective devices indicate blocks of functional units. A portion or all of the respective constituent components of each device can be achieved by an arbitrary combination of an information processing device 1000 as illustrated in, for example, FIG. 15 and programs. The information processing device 1000 includes, as an example, the following components.
A central processing unit (CPU) 1001
A read only memory (ROM) 1002
A random access memory (RAM) 1003
A program 1004 to be loaded in the RAM 1003
A storage device 1005 storing the program 1004
A drive device 1007 performing reading and writing from and to a recording medium 1006
A communication interface 1008 connecting to a communication network 1009
An input and output interface 1010 performing input and output of data
A bus 1011 interconnecting the respective constituent components

The respective constituent components of the device in each example embodiment are achieved by the CPU 1001 acquiring and executing the program 1004 that achieves the functions. The program 1004 that achieves the functions of the respective constituent components of the respective devices is, for example, stored in the storage device 1005 or the RAM 1003 in advance and is read by the CPU 1001 as needed. Note that the program 1004 may be supplied to the CPU 1001 via the communication network 1009 or the program 1004 may be stored in the recording medium 1006 in advance and the drive device 1007 may read and supply the program to the CPU 1001.

Various variations are conceivable for methods for achieving each device. For example, each device may be achieved, with respect to each constituent component, by an arbitrary combination of a separate information processing device 1000 and a separate program. In addition, a plurality of constituent components included in each device may be achieved by an arbitrary combination of one information processing device 1000 and a program.

In addition, a portion or all of the respective constituent components of each device are achieved by general-purpose or dedicated circuits including processors and the like and a combination thereof. The circuits may be configured by a single chip or a plurality of chips interconnected through a bus. A portion or all of the respective constituent components of each device may be achieved by a combination of the above-described circuits or the like and programs.

When a portion or all of the respective constituent components of each device are achieved by a plurality of information processing devices, circuits, or the like, the plurality of information processing devices, circuits, or the like may be arranged in a centralized manner or arranged in a distributed manner. For example, the information processing devices, circuits, or the like may be achieved in a form, such as a client/server system and a cloud computing system, in which the respective information processing devices, circuits, or the like are interconnected via a communication network.

Before the respective example embodiments are described, a correlation-based leakage detection method will be described. The correlation-based leakage detection method is related to a method that analyzing devices that will be described in the following respective example embodiments use.

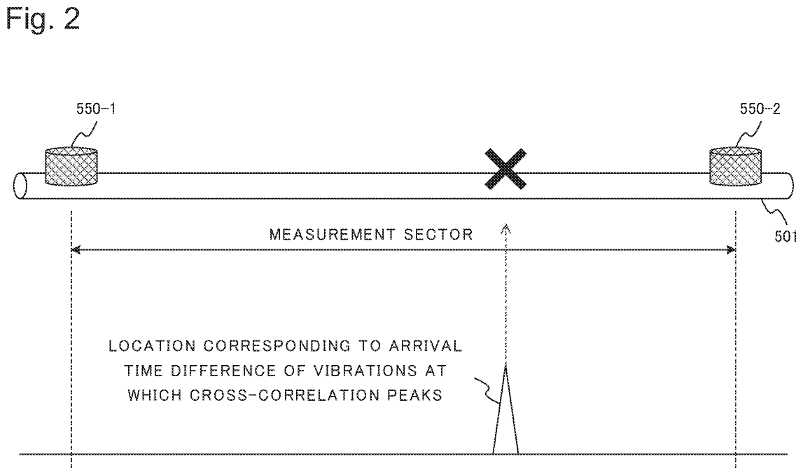

FIG. 2 illustrates an example of a case where leakage of fluid, such as water, from a pipeline is detected by means of the correlation-based leakage detection method. In the example illustrated in FIG. 2, a pair of measuring instruments 550, that is, measuring instruments 550-1 and 550-2, are installed on a pipeline 501. Each of the measuring instruments 550 measures vibration that propagates through the pipeline or fluid inside the pipeline.

In the correlation-based leakage detection method, a location at which a vibration is generated is identified based on an arrival time difference of vibrations at which a cross-correlation function calculated with respect to a pair of waveforms of vibrations detected by the respective measuring instruments 550-1 and 550-2 peaks. The peak in the cross-correlation function indicates, for example, a place at which, when the cross-correlation function is calculated for a pair of waveforms of vibrations detected by the measuring instruments 550-1 and 550-2, the cross-correlation function is maximized.

When the correlation-based leakage detection method is used to find a place at which leakage has occurred, a location identified in such a way as described above is considered to be a place at which leakage has occurred when the magnitudes of peaks in cross-correlation function satisfy a predetermined condition (that is, it is determined that a vibration caused by leakage is generated).

A generation location of vibration identified by the above-described correlation-based leakage detection method is a location between points at which the respective measuring instruments 550-1 and 550-2 are installed. That is, a pipeline laid between the measuring instruments 550-1 and 550-2 is a measurement sector in the correlation-based leakage detection method. Meanwhile, there is a case where a vibration generated outside a measurement sector propagates to the pipeline 501 in the measurement sector and is detected by the measuring instruments 550-1 and 550-2. Thus, there is a case where the generation location of vibrations identified by using the correlation-based leakage detection method is different from a location at which the vibration is actually generated.

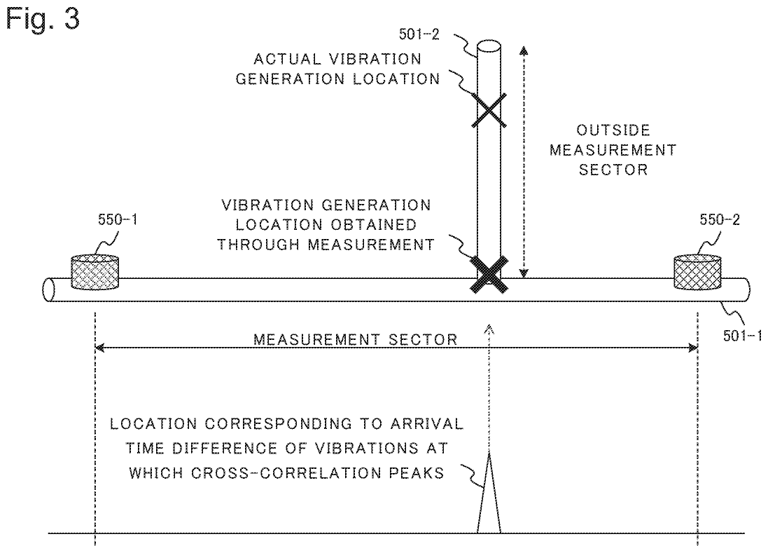

FIG. 3 illustrates a case where use of the correlation-based leakage detection method causes a location different from a location at which a vibration is actually generated to be identified as a generation location of the detected vibrations. In the example illustrated in FIG. 3, a pipeline 501-1 on which vibration is to be measured is connected to another pipeline 501-2. The pipeline 501-2 is connected to the pipeline 501-1 within the above-described measurement sector on the pipeline 501-1. The pipeline 501-2 is not defined as a pipeline on which the above-described measurement by means of the correlation-based leakage detection method is to be performed.

A case is assumed where, in the example illustrated in FIG. 3, a vibration caused by leakage or the like is generated on the pipeline 501-2. In this case, it is assumed that a vibration is generated at a location illustrated as an “actual vibration generation location”. The pipeline 501-2 is a sector outside the measurement sector in the leakage detection by means of the correlation-based leakage detection method. In this example, use of the correlation-based leakage detection method causes a location at which the pipelines 501-1 and 501-2 are connected to each other (that is, a location illustrated as a “vibration generation location obtained through measurement”) to be identified as a generation location of the detected vibrations.

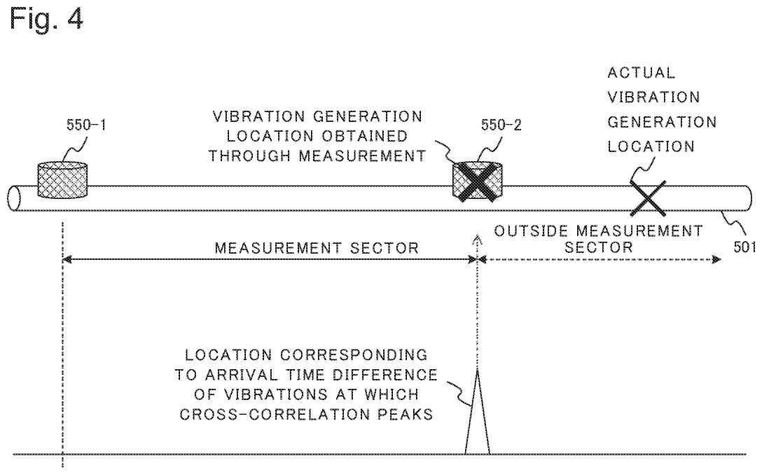

In addition, FIG. 4 illustrates another case where use of the correlation-based leakage detection method causes a location different from a location at which a vibration is actually generated to be identified as a generation location of the detected vibrations.

In the example illustrated in FIG. 4, a vibration caused by leakage or the like is generated at a point outside a sector between the measuring instruments 550-1 and 550-2, which is a measurement sector, on the pipeline 501, as illustrated as an “actual vibration generation location”. The point is contained in a sector outside the measurement sector in the leakage detection by means of the correlation-based leakage detection method. In this case, as illustrated as a “vibration generation location obtained through measurement”, a point at which a measuring instrument 550 on the side closer to the point at which the detected vibrations are generated is installed is identified as a generation location of the detected vibrations.

In addition, use of the correlation-based leakage detection method enables calculation of a location at which a vibration is generated. However, in the method, no cause by which a vibration is generated is taken into consideration. Thus, there is a possibility that, when, for example, the correlation-based leakage detection method is used for detecting water leakage from water pipelines, a vibration generated caused by use of water is erroneously determined as a vibration caused by water leakage.

That is, when leakage of fluid, such as water, from pipelines is to be detected using the correlation-based leakage detection method, it is required to appropriately determine a location at which a vibration is actually generated, a cause by which the detected vibrations are generated, and the like based on the generation location and the like of the detected vibrations identified by the method. Analyzing devices and the like in the following respective example embodiments enable the above-described determination to be performed with high precision.

Note that, in the following description of the respective example embodiments, it is assumed that pipelines are pipelines constituting a water supply network. Note, however, that the pipelines are not limited to pipelines constituting a water supply network. The pipelines may be pipelines for transporting another type of fluid or pipelines used for other purposes.

### First Example Embodiment

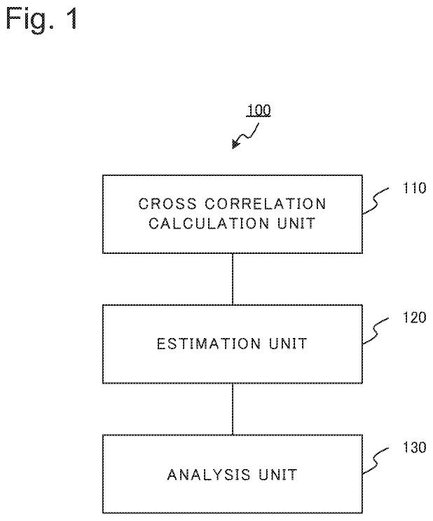

Next, a first example embodiment of the present invention will be described. FIG. 1 is a diagram illustrating an analyzing device in the first example embodiment of the present invention.

As illustrated in FIG. 1, an analyzing device 100 in the first example embodiment of the present invention includes a cross correlation calculation unit 110, an estimation unit 120, and an analysis unit 130. The cross correlation calculation unit 110 is configured to calculate cross-correlation function between vibrations detected at a pair of points contained in a measurement sector of a pipeline. The estimation unit 120 is configured to estimate a cause of the detected vibrations based on continuity of peaks in the cross-correlation function.

The analysis unit 130 is configured to analyze an actual generation location of the detected vibrations and an actual cause of the detected vibrations based on the estimated generation location and cause of the detected vibrations that are estimated based on peaks in the cross-correlation function and information on a configuration of a pipeline network.

As described above, the analyzing device 100 performs analyzes based on waveforms of the detected vibrations detected at each of a pair of points on a pipeline 501, and the like. Measurement of vibration is performed by measuring instruments 550 installed on a pipeline. In general, a sector between a pair of points at which the pair of measuring instruments 550 are respectively installed serves as a measurement sector. In addition, the analyzing device 100 mainly sets as a target for analysis a pipeline network constituted by a plurality of pipelines 501 connected to one another.

The measuring instruments 550 may only be capable of detecting vibration propagating through a pipeline or fluid inside the pipeline, and the capability can be based on any type of principle. While, for example, vibration sensors, water pressure sensors, hydrophones, or the like are used as the measuring instruments 550, other types of sensors may be used.

In addition, the analyzing device 100 and the respective measuring instruments 550 are connected to each other via, for example, a wired or wireless communication network. Alternatively, data on vibrations that are measured by the measuring instruments 550 may be transferred to the analyzing device 100 via an arbitrary type of recording medium.

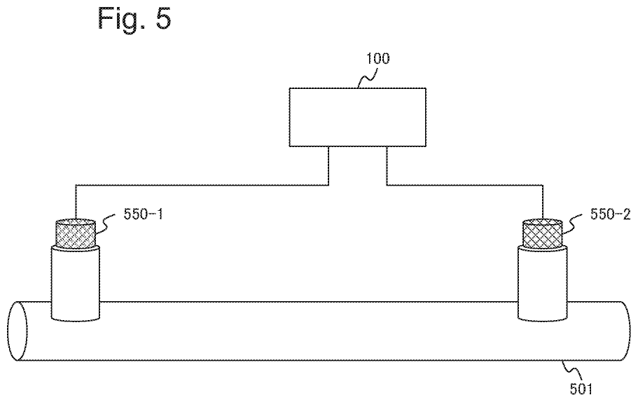

FIG. 5 illustrates an example of a case where the analyzing device 100 and the respective measuring instruments 550 are connected to each other via a communication network. In the example illustrated in FIG. 5, the measuring instruments 550-1 and 550-2 are respectively attached to, for example, valve plugs 502 disposed to the pipeline 501. Note, however, that places to which the measuring instruments 550-1 and 550-2 are attached are not limited to the valve plugs 502. Places to which the measuring instruments 550 are attached are not limited specifically as long as a vibration propagating through the pipeline or fluid inside the pipeline can be detected at the places.

Note that, in the example illustrated in FIG. 5, the pair of measuring instruments 550 are connected to the analyzing device 100. However, the number of the measuring instruments 550 connected to the analyzing device 100 is not limited specifically. The analyzing device 100 may be connected to three or more measuring instruments. When connected to three or more measuring instruments 550, the analyzing device 100 performs analysis based on results of measurement by two measuring instruments 550 adjacent to each other among the connected measuring instruments 550.

Next, the respective constituent components of the analyzing device 100 in the present example embodiment will be described.

The cross correlation calculation unit 110 calculates cross-correlation function with respect to detected vibrations detected at a pair of points on a pipeline contained in a measurement sector. In the cross correlation calculation unit 110, for example, a pair of vibration waveforms measured by the measuring instruments 550-1 and 550-2 illustrated in FIG. 5 are used as a vibration detected at a pair of points on the pipeline. That is, the cross correlation calculation unit 110 calculates a cross-correlation function with respect to a pair of vibration waveforms, measured by the pair of measuring instruments 550, during periods of a predetermined length that are the same period of time. The cross correlation calculation unit 110, for example, divides a pair of continuously-measured vibration waveforms at each period of the predetermined length and calculates a cross-correlation function with respect to each of a plurality of pairs of divided vibration waveforms. Note that, to the pair of measuring instruments 550, a mechanism for synchronizing time points at which the vibrations are respectively measured by the measuring instruments 550 (suppressing a difference between time points at which the vibrations are respectively measured by the pair of measuring instruments 550 within a predetermined range) in such a way that the vibrations are measured during the same period of time may be disposed.

The above-described period of a predetermined length is a duration of a constant length determined in advance. The period of the predetermined length may only be appropriately determined according to a procedure and the like used when a cause of the detected vibrations is estimated by the estimation unit 120. Note, however, that the predetermined length may have error as long as the error falls within a range not influencing the estimation of a cause of the detected vibrations. In addition, the predetermined length may be changed depending on a period of time in which measurement is performed, such as day or night. When it is difficult to perform processing, such as identification of a location at which the detected vibrations are generated and estimation of a cause of the detected vibrations, within a duration of a length determined in advance, the length may be changed. In this case, the length may be shortened or extended.

In addition, when the cross correlation calculation unit 110 calculates cross-correlation function, an acquisition procedure and the like of vibration waveforms to be acquired are not limited specifically. In this case, the cross correlation calculation unit 110 may acquire, as a vibration waveform during each period of the predetermined length, a vibration waveform of the predetermined length by extracting the vibration waveform out of vibration waveform data having been measured for a longer duration than the predetermined length. Moreover, the cross correlation calculation unit 110 may acquire, as a vibration waveform during each period of the predetermined length, vibration waveform data obtained through repeating measurement during each period of the predetermined length.

Note that, in the cross correlation calculation unit 110, a known method is appropriately used when cross-correlation function is calculated. In the present example embodiment, a specific means for calculating cross-correlation function is not limited in particular.

The estimation unit 120 estimates a cause of the detected vibrations based on continuity of peaks in cross-correlation function calculated by the cross correlation calculation unit 110. Further, the estimation unit 120 may estimate a location at which the detected vibrations are generated based on the peaks in the cross-correlation function. In the estimation of a location at which the detected vibrations are generated, continuity of the peaks may be taken into consideration. Regarding the estimation of a cause of the detected vibrations and the estimation of a location at which the detected vibrations are generated, each may be performed independently or both may be performed in conjunction with each other.

The estimation unit 120 first estimates a location at which a vibration is generated based on arrival time differences of the vibration at which the cross-correlation function calculated by the cross correlation calculation unit 110 peak. The estimation unit 120, using, for example, the above-described correlation-based leakage detection method, estimates a location at which the detected vibrations are generated. A generation location of the detected vibrations estimated by the estimation unit 120 is a location contained in the above-described measurement sector. That is, when the detected vibrations are generated at a location outside the measurement sector and the vibration has propagated to the measurement sector, a location to which the vibration has propagated is estimated as a generation location of the detected vibrations by the estimation unit 120.

As described in the above-described example, when, for example, a pipeline on which measurement is performed is connected to another pipeline within the measurement sector and the detected vibrations are generated on the another pipeline, a location of the connection between the pipelines is estimated as a generation location of the detected vibrations by the estimation unit 120. In addition, when the detected vibrations are generated at a location outside the measurement sector on the pipeline on which measurement is performed, a location at which either of the measuring instruments 550 is installed is estimated as a generation location of the detected vibrations by the estimation unit 120.

In addition, the estimation unit 120 estimates a cause of the detected vibrations based on continuity of peaks in cross-correlation function. The estimation unit 120 estimates whether the detected vibrations are caused by leakage of fluid from a pipeline or the detected vibrations are caused by a cause other than leakage based on whether peaks in cross-correlation function calculated by the cross correlation calculation unit 110 consecutively satisfy a predetermined condition. Note that examples of the predetermined condition include a threshold value relating to the magnitude of a peak of a cross-correlation.

When whether leakage has occurred is determined based on a vibration detected on a pipeline, it is required to discriminate a cause of the detected vibrations in addition to a location at which the vibrations detected by the measuring instruments 550 or the like is generated. That is, when whether leakage has occurred is determined, it is required to discriminate whether the vibration is caused by leakage or the vibration is caused by a cause other than leakage. Examples of vibration caused by a cause other than leakage include vibration generated on the pipeline 501 caused by use of fluid, such as water, flowing through the pipeline 501 by a facility connected to the pipeline 501. Vibration caused by such a cause other than leakage is also referred to as disturbance vibration.

In addition, characteristics of vibration generated by use of water or the like resemble characteristics of vibration caused by leakage. Therefore, it is sometimes difficult to, by means of limiting a frequency band or the like, discriminate vibration caused by use of water or the like from vibration caused by leakage.

Meanwhile, a period for which vibration continues generally differs depending on a cause of the detected vibrations. For example, when a vibration is caused by leakage, the vibration is continuously generated unless the leakage is repaired. In this case, when cross-correlation function is calculated with respect to respective pairs of vibration waveforms during periods of the predetermined length, into which continuously-measured vibration waveforms are divided, it is anticipated that peaks in the cross-correlation function are consecutively of a certain magnitude or greater.

In contrast, vibration which is generated on the pipeline 501 and is caused by use of water is generally generated only when water or the like is used in a facility connected to the pipeline 501. When water or the like is not used, no vibration caused by use of water is generated. In addition, it can be assumed that, in general, the detected vibrations that are measured by the measuring instruments 550 due to a vibration being applied to the pipeline 501 from the outside of the pipeline 501, such as a vibration being applied to a surface of the ground located above the pipeline 501 buried underground, is often generated intermittently. In this case, when cross-correlation function is calculated with respect to respective pairs of vibration waveforms during periods of the predetermined length, into which continuously-measured vibration waveforms are divided, it is anticipated that peaks in the cross-correlation function vary depending on the occurrence or non-occurrence of a vibration.

Thus, the estimation unit 120 determines whether the magnitudes of respective peaks in cross-correlation function calculated with respect to respective pairs of vibration waveforms during a plurality of consecutive periods of the predetermined length satisfy a predetermined condition. The pairs of vibration waveforms are pairs of vibration waveforms into which a pair of vibration waveforms continuously measured by the measuring instruments 550 are divided at each period of the predetermined length. When the magnitudes of the respective peaks in the cross-correlation function satisfy the predetermined condition consecutively more than a predetermined number of times (or a predetermined number of times or more), the estimation unit 120 estimates that the measured vibrations are caused by leakage.

That is, when vibrations are continuously measured by the measuring instruments 550, the estimation unit 120 determines whether the magnitudes of peaks in cross-correlation function satisfy the predetermined condition with respect to respective pairs of vibration waveforms into which a pair of vibration waveforms are divided at each period of the predetermined length. The cross-correlation function is cross-correlation function that were calculate by the cross correlation calculation unit 110. The determination is repeatedly performed for the respective calculated cross-correlation function. When the number of times that the magnitudes of the peaks in the cross-correlation function are consecutively determined to satisfy the predetermined condition exceeds the predetermined number of times (reaches the predetermined number of times), the estimation unit 120 estimates that the measured vibration is caused by leakage.

In addition, when the magnitudes of the respective peaks in the cross-correlation function do not satisfy the predetermined condition consecutively more than a predetermined number of times, the estimation unit 120 estimates that the measured vibration is a vibration caused by a cause other than leakage. Although examples of such a cause other than leakage include use of water or the like, the cause may be any other cause as long as other than leakage.

Note that the above-described number of times may only be appropriately determined according to conditions and the like of the pipeline network in such a way that a vibration caused by leakage and a vibration caused by a cause other than leakage are discriminable from each other. Although examples of conditions of the pipeline network include a usage status of water, and the like when the pipeline network is a water supply network, other conditions may be taken into consideration.

In addition, examples of the predetermined condition include a threshold value for the magnitudes of peaks in cross-correlation function. That is, when the magnitude of a peak in a cross-correlation function exceeds the threshold value, it is determined that the detected vibrations are generated on the pipeline by some cause. The magnitude of the threshold value may only be appropriately determined according to various conditions, such as types of a pipeline in the measurement sector and the measuring instruments 550, amplitude of a vibration to be measured, and the like. In addition, as a predetermined condition, another condition enabling generation of a vibration on a pipeline to be determined may be used

The analysis unit 130 performs analysis on a cause of a vibration based on a generation location of the detected vibrations estimated by the estimation unit 120 based on peaks in cross-correlation function and information on a configuration of a pipeline network. In addition, the analysis unit 130 performs analysis on a location at which the vibration is actually generated based on the above-described information. Regarding the analysis on a cause of a vibration and the analysis on a cause of the detected vibrations, each may be performed independently or both may be performed in conjunction with each other.

As illustrated in the examples in FIG. 3 and the like, there is a possibility that a generation location of the detected vibrations identified by the estimation unit 120 is different from a location at which the detected vibrations are actually generated. In addition, when the detected vibrations are estimated to be caused by a cause other than leakage by the estimation unit 120, a configuration in which a facility or the like that uses fluid, such as water, flowing through the pipeline is connected at a location at which the detected vibrations are generated can serve as a basis for proving validity of the estimation. That is, there is a possibility that further applying the information on the configuration of the pipeline network to a result of estimation by the estimation unit 120 enables precision of analysis on a location at which the detected vibrations are generated and a cause of the detected vibrations to be improved.

Thus, the analysis unit 130 performs analysis on an actual location at which the detected vibrations are generated and an actual cause of the detected vibrations, using the information on the configuration of the pipeline network.

In the information on the configuration of the pipeline network, for example, information on connection relationships of the pipelines 501 constituting the pipeline network is included. In the information on connection relationships of the pipelines 501, information on connection relationships of a plurality of pipelines 501, facilities connected to the pipelines 501, and the like is included. Note, however, that other information different from the above-described information may be used as information on the configuration of the pipeline network as long as such other information can be used for estimation of an actual location at which the detected vibrations are generated and an actual cause of the detected vibrations. In addition, when the pipeline network is a water supply network, houses, industrial facilities, commercial facilities, and the like are included in the facilities connected to the pipelines 501.

In addition, the information on the configuration of the pipeline network is stored in a not-illustrated storage device or the like as registry information in advance. The analysis unit 130 acquires the information on the configuration of the pipeline network by reading the information from the storage device as needed. In addition, the analysis unit 130 may acquire the information on the configuration of the pipeline network retained by a device external to the analyzing device 100 via a communication network or the like when performing analysis.

As an example, the analysis unit 130 performs analysis, using information on a connection relationship between pipelines 501 at a generation location of the detected vibrations estimated by the estimation unit 120 among the information on the configuration of the pipeline network. When, to a pipeline 501 on which measurement is performed by the measuring instruments 550, another pipeline 501 is connected at a generation location of the detected vibrations estimated by the estimation unit 120, the analysis unit 130 analyzes that there is a possibility that, in actuality, the detected vibrations are generated on the other pipeline.

For example, a case is assumed where the estimation unit 120 has estimated that the detected vibrations are caused by leakage and the information on the configuration of the pipeline network indicates that another pipeline is connected at a generation location of the detected vibrations estimated by the estimation unit 120. In this case, the analysis unit 130 analyzes that there is a possibility that the leakage has occurred on the another pipeline instead of the pipeline 501 on which measurement is performed by the measuring instruments 550.

In addition, a case is assumed where the estimation unit 120 has estimated that the detected vibrations are caused by a cause other than leakage (use of water or the like) and the information on the configuration of the pipeline network indicates that another pipeline is connected at an estimated generation location of the detected vibrations. In this case, the analysis unit 130 analyzes that there is a possibility that the detected vibrations caused by a cause other than leakage are generated on the another pipeline instead of the pipeline 501 on which measurement is performed by the measuring instruments 550.

Further, when the pipeline 501 is a portion of a water supply network and a leading-in pipe to a facility using fluid, such as water, is connected at a generation location of the detected vibrations, the analysis unit 130 further analyzes validity of an estimation result by the estimation unit 120 relating to a cause of the detected vibrations.

For example, a case is assumed where the estimation unit 120 has estimated that the detected vibrations are caused by a cause other than leakage (use of water or the like) and the information on the configuration of the pipeline network indicates that a leading-in pipe to a house is connected to the pipeline 501 at a generation location of the detected vibrations. Since, in general, water is used in a house, it is considered that the information on the configuration of the pipeline network indicates that an estimation result of a cause by the estimation unit 120 is valid. Thus, in this case, the analysis unit 130 analyzes, with respect to a cause of the detected vibrations, that use of water in the house is the cause.

In addition, a case is assumed where the estimation unit 120 has estimated that the detected vibrations are caused by leakage of fluid and the information on the configuration of the pipeline network indicates that a leading-in pipe to a facility using water is connected at a generation location of the detected vibrations. In this case, the analysis unit 130 analyzes a cause of the detected vibrations based on the type of the facility connected to the pipeline 501 via the leading-in pipe.

For example, in this case, a case where the facility is a house is assumed. It is considered that, in the house, the possibility that water is used continuously is low. That is, it is considered that the possibility that use of water is a primary cause of the detected vibrations is low. Thus, the analysis unit 130 analyzes that the possibility that leakage has occurred is high.

On the other hand, a case where the above-described facility is an industrial facility is assumed. In an industrial facility, there is a possibility that water is used continuously. Therefore, it is considered that there is a possibility that the detected vibrations that are estimated to be caused by leakage by the estimation unit 120 are generated caused by use of water. Thus, the analysis unit 130 analyzes that the possibility that leakage has occurred is low.

As described above, the analysis unit 130 using the information on the configuration of the pipeline network enables a possibility of leakage and various possibilities relating to an actual generation location of a vibration to be analyzed. The analysis unit 130 performing analysis using the information on the configuration of the pipeline network enables erroneous discrimination relating to the occurrence or non-occurrence of leakage and an actual generation location of leakage to be prevented.

Note that a result of analysis performed by the analysis unit 130 is appropriately output via a not-illustrated display device or the like. A location at which the detected vibrations are generated is output in such a manner that a place at which the detected vibrations are generated is plotted on a map illustrating the pipeline network. The analysis unit 130 may output coordinate values of a location at which the detected vibrations are generated. Further, the analysis unit 130 may output a result of analysis on a cause of the detected vibrations in conjunction with a location at which the detected vibrations are generated.

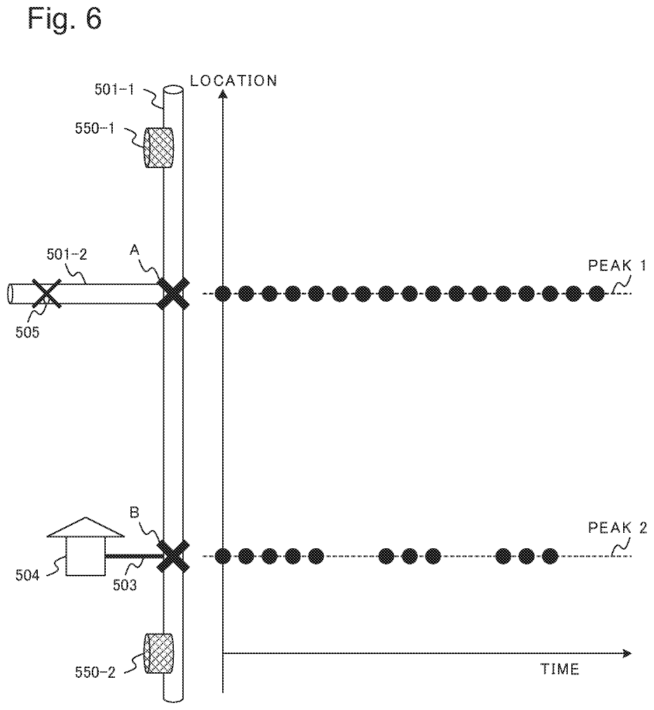

Processing of analysis and the like mainly performed by the estimation unit 120 or analysis unit 130 of the analyzing device 100 will be further described using specific examples. FIG. 6 is a diagram illustrating an example of pipelines to be analyzed by the analyzing device 100. On the left side in FIG. 6, a pipeline network to be analyzed by the analyzing device 100 including the estimation unit 120 or the analysis unit 130 is illustrated. In the example, the pipeline network to be analyzed is, for example, a portion of a water supply network.

In FIG. 6, the measuring instruments 550-1 and 550-2 are installed on a pipeline 501-1. That is, in the example illustrated in FIG. 6, it is assumed that a measurement sector is set on the pipeline 501-1 and the analyzing device 100 performs analysis and the like with respect to the measurement sector. In addition, to the pipeline 501-1, a pipeline 501-2 is connected at a point A in FIG. 6. Further, to the pipeline 501-1, a leading-in pipe 503 to a house 504 is connected at a point B in FIG. 6.

In addition, in the coordinate system on the right side in FIG. 6, relationships among time points at which pairs of vibration waveforms that were used when cross-correlation function were calculated were measured, locations on the pipeline corresponding to peaks in the cross-correlation function, and the magnitudes of the peaks in the cross-correlation function are illustrated.

In the coordinate system illustrated in FIG. 6, the ordinate represents locations on the pipeline corresponding to peaks in cross-correlation function and the abscissa represents time points at which pairs of vibration waveforms that were used when the cross-correlation function were calculated were measured. When a cross-correlation function is calculated, a pair of vibration waveforms measured during a period of an appropriately-determined length are used. Based on an arrival time difference of the detected vibrations at which the cross-correlation function peaks, a location at which the detected vibrations are generated is obtained. When the magnitude of the peak in the cross-correlation function satisfies a predetermined condition, a filled circle mark is plotted at a position in the coordinate system corresponding to the location and the period of time during which the pair of vibration waveforms were measured.

In the example, a case is assumed where a leaking hole 505 is formed on the pipeline 501-2 and water leaks from the leaking hole 505. In this case, it is preferably required that an analysis result indicating that there is a possibility that leakage has occurred on the pipeline 501-2 is obtained by the analyzing device 100.

In this case, cross-correlation function for pairs of vibration waveforms measured by the measuring instruments 550-1 and 550-2 is calculated by the cross correlation calculation unit 110. In the respective measuring instruments 550-1 and 550-2, measurement is performed continuously. For a plurality of pairs of vibration waveforms during respective periods of a predetermined length into which a pair of continuous measurement results are divided, cross-correlation function is respectively calculated by the cross correlation calculation unit 110.

Next, a generation location and cause of the detected vibrations are estimated by the estimation unit 120. The estimation unit 120 first estimates the location at which the detected vibrations are generated based on peaks in the cross-correlation function calculated with respect to the respective pairs of vibration waveforms during a plurality of consecutive periods of the predetermined length. Obtained results are plotted as indicated by marks along the line labeled as “peak 1” in the coordinate system on the right side in FIG. 6. The above-described filled-circle marks are plotted at positions in the coordinate system corresponding to the point A on the pipeline 501-1. That is, the estimation unit 120 estimates that the location at which the detected vibrations are generated is the point A on the pipeline 501-1.

Further, the estimation unit 120 estimates a cause of the detected vibrations based on continuity of peaks in the cross-correlation function. Along the line labeled as “peak 1” in FIG. 6, filled circles are consecutively plotted at positions in the coordinate system corresponding to the point A. That is, it is considered that the vibrations are generated continuously. Thus, the estimation unit 120 estimates that the measured vibrations are vibrations caused by leakage.

For such an estimation result, the analysis unit 130 further performs analysis on an actual location at which the detected vibrations are generated and an actual cause of the detected vibrations, using the information on the configuration of the pipeline network.

According to the information on the configuration of the pipeline network, the pipeline 501-2 is connected to the pipeline 501-1 at the above-described point A. Therefore, it is considered that, in addition to a possibility that leakage has occurred at the point A, there is a possibility that leakage has occurred on the pipeline 501-2 and a vibration caused by the leakage has propagated to the point A on the pipeline 501-1. Thus, the analysis unit 130 analyzes that there is a possibility that leakage has occurred on the pipeline 501-2. That is, the above-described desirable analysis result is obtained.

In addition, a case is assumed where, in the example illustrated in FIG. 6, water is used in the house 504 and a vibration generated as a result of the use of water propagates to the pipeline 501-1 via the leading-in pipe 503. In this case, it is preferably required that an analysis result indicating that a vibration caused by use of water is generated at the point B, which is a connection point between the pipeline 501-1 and the leading-in pipe 503, is obtained by the analyzing device 100.

In this case, cross-correlation function between pairs of vibration waveforms measured by the measuring instruments 550-1 and 550-2 are also calculated by the cross correlation calculation unit 110. The estimation unit 120, as with the afore-described example, first estimates, for the cross-correlation function calculated with respect to the respective pairs of vibration waveforms during a plurality of periods of the predetermined length, which were continuously measured, respective locations at which the detected vibrations are generated based on peaks in the cross-correlation function. Obtained results are plotted as indicated by marks along the line labeled as “peak 2” in FIG. 6. The above-described filled-circle marks are plotted at positions in the coordinate system corresponding to the point B on the pipeline 501-1. That is, the estimation unit 120 estimates that the location at which the detected vibrations are generated is the point B on the pipeline 501-1.

Further, the estimation unit 120 estimates a cause of the detected vibrations based on continuity of peaks in the cross-correlation function. Along the line labeled as “peak 2” in FIG. 6, differing from the above-described case of “peak 1”, filled circles are intermittently plotted at positions in the coordinate system corresponding to the point B. That is, among the periods of time during which measurement was performed by the measuring instruments 550-1 and 550-2, periods of time in which no vibration that causes a cross-correlation function to peak distinctively was generated are included. Thus, the estimation unit 120 estimates that the measured vibration is a vibration caused by a cause other than leakage.

For such an estimation result, the analysis unit 130 further performs analysis on an actual location at which the detected vibrations are generated and an actual cause of the detected vibrations, using the information on the configuration of the pipeline network.

According to the information on the configuration of the pipeline network, the leading-in pipe 503 is connected to the pipeline 501-1 at the above-described point B. Therefore, it is considered that there is a possibility that a vibration generated by use of water in the house 504 propagates to the pipeline 501-1 via the leading-in pipe 503. Thus, the analysis unit 130 analyzes that there is a possibility that the vibration measured at the point B on the pipeline 501-1 is caused by use of water. That is, the above-described desirable analysis result is obtained.

Note that the estimation unit 120 and the analysis unit 130 may estimate a cause of the detected vibrations in accordance with a procedure different from the above-described procedure. For example, the analysis unit 130 may, using the information on the configuration of the pipeline network, narrow down diagnosis results to a result indicating a location that, even when estimated to be a vibration generation location based on cross-correlation function, may be different from an actual leakage occurrence location with high possibility, in advance. The estimation unit 120 may perform estimation based on continuity of peaks in the cross-correlation function for the narrowed-down diagnosis result.

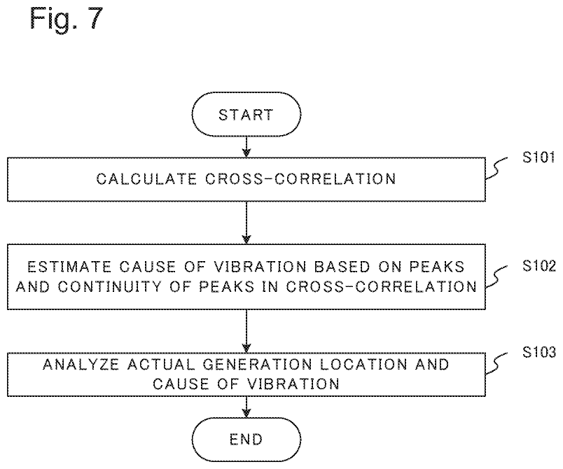

Next, with reference to a flowchart illustrated in FIG. 7, operation of the analyzing device 100 in the present example embodiment will be described.

First, the cross correlation calculation unit 110 calculates cross-correlation function with respect to pairs of vibration waveforms during periods of a predetermined length that were measured at a pair of points on a pipeline contained in a measurement sector (step S101).

Next, the estimation unit 120 estimates a generation location of the detected vibrations and a cause of the detected vibrations based on peaks and continuity of the peaks in the cross-correlation function calculated in step S101 (step S102).

As an example in this case, the estimation unit 120 first estimates a location at which the detected vibrations are generated based on arrival time differences between the pairs of vibration waveforms at which the respective cross-correlation function for the plurality of pairs of consecutive vibration waveforms of the predetermined length, which were calculated in step S101, peak. The estimation unit 120 estimates a cause of the detected vibrations based on whether the number of times that the magnitudes of the peaks in the cross-correlation function are consecutively determined to satisfy a predetermined condition exceeds a predetermined number of times.

Next, the analysis unit 130 analyzes an actual location at which the detected vibrations are generated and an actual cause of the detected vibrations based on the generation location of the detected vibrations estimated in step S102 and information on a configuration of a pipeline network (step S103). As an example in this case, first, the analysis unit 130 acquires the information on the configuration of the pipeline network. The analysis unit 130 performs analysis, using information on a connection relationship between pipelines 501 at the generation location of the detected vibrations estimated in step S102. The analysis unit 130 analyzes a possibility that leakage has occurred on a pipeline that is connected to the pipeline on which measurement was performed, and the like.

Note that the operation of the analyzing device 100 is not limited to the above-described operational sequence. For example, when the analysis unit 130 narrows down diagnosis results in advance and the estimation unit 120 performs estimation for the narrowed-down diagnosis results, the sequence of steps S102 and S103 may be reversed. In addition, in this case or the like, the processing in steps S102 and S103 may be appropriately performed in a repeated manner.

As described thus far, the analyzing device 100 in the first example embodiment of the present invention performs analysis on a location at which the detected vibrations are generated and a cause of the detected vibrations that are estimated based on peaks and the like in cross-correlation function for pairs of vibration waveforms, using information on a configuration of a pipeline network as well.

In a water supply network, when the detected vibrations are generated on a pipeline by a cause other than leakage, use of water is one of the primary causes of such a vibration. Characteristics of vibration generated by use of water resemble characteristics of vibration generated by leakage. Therefore, when leakage is to be detected, it is sometimes difficult to discriminate leakage by means of limiting a frequency band to be analyzed and the like.

In addition, an actual pipeline network, such as a water supply network, is sometimes constituted by a plurality of pipelines connected to each other. When an occurrence of leakage is detected in such a pipeline network, there is also a possibility that the leakage has occurred on another pipeline that is different from a pipeline on which a vibration was measured.

On the other hand, in the analyzing device 100, the estimation unit 120 estimates a cause of the detected vibrations based on continuity of peaks in cross-correlation function. This configuration enables whether the detected vibrations are caused by leakage or caused by a cause other than leakage to be discriminated. In addition, in the analyzing device 100, the analysis unit 130 performs analysis on an actual location at which the detected vibrations are generated and an actual cause of the detected vibrations based on information on a configuration of a pipeline network. This configuration enables a possibility that the leakage has occurred on another pipeline that is different from a pipeline on which the detected vibrations are measured, and the like to be revealed. This configuration also enables validity of an estimation by the estimation unit 120 to be verified.

Therefore, the analyzing device 100 in the present example embodiment enables prevention of erroneous discrimination.

### Second Example Embodiment

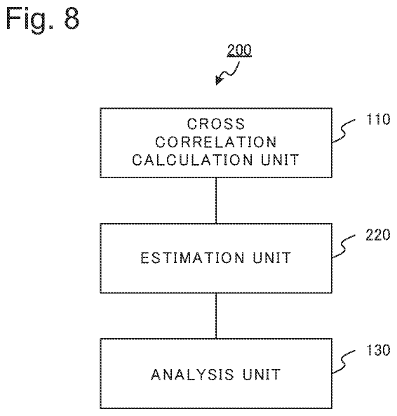

Next, a second example embodiment of the present invention will be described. FIG. 8 is a diagram illustrating an analyzing device in the second example embodiment of the present invention.

As illustrated in FIG. 8, an analyzing device 200 in the third example embodiment of the present invention includes a cross correlation calculation unit 110, an estimation unit 220, and an analysis unit 130. The cross correlation calculation unit 110 and the analysis unit 130 are constituent components similar to the cross correlation calculation unit 110 and the analysis unit 130 that the analyzing device 100 in the first example embodiment includes, respectively. The estimation unit 220 is configured to estimate a location at which the detected vibrations are generated and a cause of the detected vibrations based on peaks in cross-correlation function, variation in the magnitudes of the peaks, and continuity of the peaks.

That is, the analyzing device 200 differs from the analyzing device 100 in the first example embodiment in including the estimation unit 220 in place of the estimation unit 120. In addition, the estimation unit 220 differs from the estimation unit 120 principally in, when estimating a cause of the detected vibrations, taking into consideration variation in the magnitudes of peaks in cross-correlation function.

Next, the respective constituent components of the analyzing device 200 in the present example embodiment will be described. Note that, with respect to a constituent component that is similar to a constituent component that the analyzing device 100 in the first example embodiment includes, a description thereof will be omitted.

The cross correlation calculation unit 110 is a constituent component similar to the cross correlation calculation unit 110 that the analyzing device 100 in the first example embodiment includes. The cross correlation calculation unit 110, as described above, calculates cross-correlation function with respect to the detected vibrations detected at a pair of points contained in a measurement sector.

The estimation unit 220 estimates a location at which the detected vibrations are generated and a cause of the detected vibrations based on peaks in cross-correlation function calculated by the cross correlation calculation unit 110, variation in the magnitudes of the peaks, and continuity of the peaks.

As described above, in the estimation unit 120 that the analyzing device 100 includes, a cause of a vibration is estimated based on continuity of peaks. The estimation unit 120 determines whether the magnitudes of respective peaks in cross-correlation function calculated for respective pairs of vibration waveforms during consecutive periods of a predetermined length satisfy a predetermined condition. When peaks in cross-correlation function do not continue long enough to satisfy a predetermined condition, the detected vibrations are estimated to be caused by a cause other than leakage.

On the other hand, in a pipeline network, such as a water supply network, a case can be assumed where fluid, such as water, flowing through pipelines is used at a plurality of adjacent places or a plurality of places on another pipeline that is connected to a pipeline on which measurement is performed by a pair of measuring instruments 550. In this case, there is a possibility that, although water is used intermittently at each place among the above-described plurality of places, a state in which water is continuously used when summed up over all of the plurality of places is brought about. That is, in this case, there is a possibility that vibrations are continuously generated on the pipelines.

When cross-correlation function is calculated for results of measurement by the pair of measuring instruments 550 in this case, there is a case where peaks in the cross-correlation function continue long enough to satisfy the predetermined condition. As a result, there is a possibility that, in the estimation of a cause of the detected vibrations performed by the estimation unit 120, an erroneous estimation, such as an estimation in which it is estimated that leakage has occurred despite that the detected vibrations are generated caused by use of water, is made.

Thus, the estimation unit 220 estimates a cause of the detected vibrations, further based on the magnitudes of the peaks in the cross-correlation function.

A vibration caused by leakage is continuously generated at a leakage point. Thus, it can be assumed that the magnitudes of peaks in cross-correlation function when a vibration caused by leakage is measured are often approximately constant. On the other hand, when vibrations are generated from different vibration generation sources at different places on a pipeline, it can be assumed that amplitude, ease of propagation, or the like differs for every generated vibration. Therefore, it can be assumed that peaks in cross-correlation function are different in magnitude for every generated vibration.

Thus, when, although water or the like is used intermittently at each place among a plurality of places, water or the like is continuously used when summed up over all of the plurality of places, and the like, taking into consideration the magnitudes of peaks in cross-correlation function enables avoidance of an erroneous estimation as described above. Note that the magnitude of a peak in a cross-correlation function is also referred to as a level of a peak in a cross-correlation function.

The estimation unit 220 first estimates a location at which the detected vibrations are generated based on arrival time differences of the detected vibrations at which the cross-correlation function calculated by the cross correlation calculation unit 110 peak. A location at which the detected vibrations are generated is estimated in a similar manner to the estimation by the estimation unit 120. That is, the estimation unit 220, using a known correlation-based leakage detection method, estimates a location at which the detected vibrations are generated.

In addition, the estimation unit 220 estimates a cause of the detected vibrations based on the magnitudes of peaks and continuity of the peaks in the cross-correlation function. The estimation unit 220, as with the estimation unit 120, estimates whether the detected vibrations are caused by leakage of fluid from the pipeline or caused by a cause other than leakage.

The estimation unit 220 determines whether the magnitudes of the respective peaks in the cross-correlation function calculated for pairs of vibration waveforms during consecutive periods of a predetermined length satisfy a predetermined condition repeatedly. In this case, when the magnitudes of the peaks in the cross-correlation function do not satisfy the predetermined condition consecutively more than a predetermined number of times, the estimation unit 220 estimates that the detected vibrations are caused by a cause other than leakage.

In contrast, when the number of continuance times of the magnitudes of the peaks in the cross-correlation function having magnitudes that satisfies the predetermined condition is more than a predetermined number of times, the estimation unit 220 also determines whether variation in the magnitudes of the peaks exceeds a predetermined range. When the magnitudes of the respective peaks in the cross-correlation function satisfy the predetermined condition consecutively more than the predetermined number of times and the variation in the magnitudes of the peaks does not exceed the predetermined range, the estimation unit 220 estimates that the measured vibration is caused by leakage. That is, when the variation in the magnitudes of the peaks in the cross-correlation function is so small as to be contained in the predetermined range, the estimation unit 220 estimates that the detected vibrations are caused by leakage.

In addition, when, although the magnitudes of the peaks in the respective cross-correlation function satisfy the predetermined condition consecutively more than the predetermined number of times, the variation in the magnitudes of the peaks exceeds the predetermined range, the estimation unit 220 estimates that the detected vibrations are caused by a cause other than leakage.

That is, when the magnitudes of the peaks in the respective cross-correlation function vary widely, exceeding the predetermined range, the estimation unit 220 estimates that the detected vibrations are caused by a cause other than leakage. Note that the above-described case where the magnitudes of the peaks in the cross-correlation function satisfy a predetermined condition consecutively more than a predetermined number of times may be a case where the magnitudes of the peaks in the cross-correlation function satisfy the predetermined condition consecutively the predetermined number of times or more.

That is, when variation in the magnitudes of the peaks in the cross-correlation function exceeds the predetermined range, in other words, variation in the magnitudes of the peaks in the cross-correlation function is large, the estimation unit 220 estimates that the detected vibrations are caused by a cause other than leakage (use of water or the like).

Variation in the magnitudes of peaks in cross-correlation function can be calculated as, for example, a difference between the magnitude of a peak in a cross-correlation function during a period of a predetermined length and the magnitude of a peak in a cross-correlation function during the succeeding period of the predetermined length. In this case, a case where variation in the magnitudes of the peaks exceeds a predetermined range corresponds to a case where the difference increases, exceeding the predetermined range.

Note, however, that variation in the magnitudes of peaks may be calculated using a criterion different from the above-described criterion. For example, variation in the magnitudes of peaks may be calculated based on a difference from a trend line of peaks in cross-correlation function during a certain period. In addition, whether variation in the magnitudes of peaks exceeds a predetermined range may be determined by further classifying peaks in cross-correlation function that satisfy the above-described predetermined condition, using a threshold value, or the like.

The analysis unit 130 is a constituent component similar to the analysis unit 130 that the analyzing device 100 in the first example embodiment includes. The analysis unit 130 analyzes an actual location at which the detected vibrations are generated and an actual cause of the detected vibrations.

Note that, in the present example embodiment, a case can be assumed where variation in the magnitudes of peaks in cross-correlation function exceeding a predetermined range causes the estimation unit 220 to estimate that the detected vibrations are caused by a cause other than leakage. In this case, the analysis unit 130 may analyze that there is a possibility that vibrations are generated at a plurality of places.

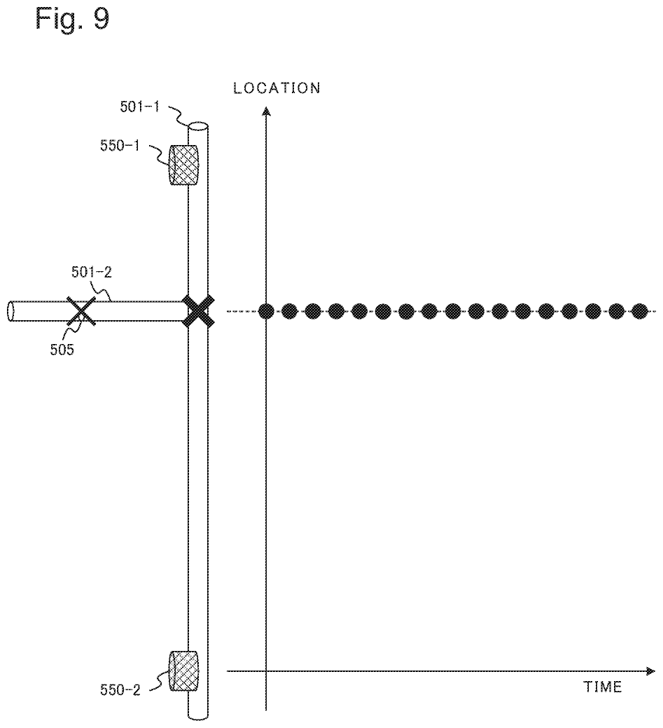

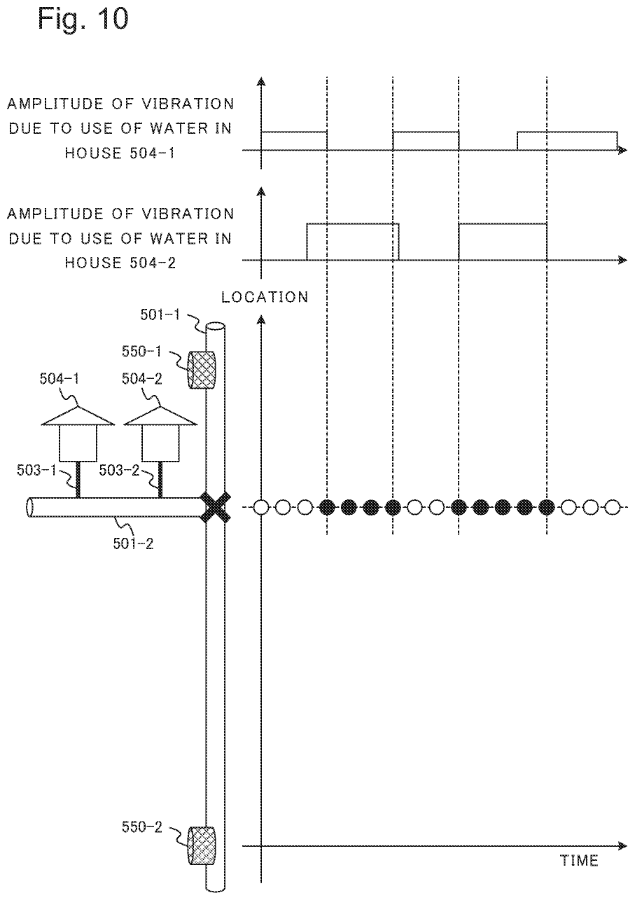

Estimation performed by the estimation unit 220 of the analyzing device 200 will be further described using specific examples illustrated in FIGS. 9 and 10. FIGS. 9 and 10 are respectively diagrams illustrating examples of pipelines to be analyzed by the analyzing device 200. On the left side in each of FIGS. 9 and 10, as with the afore-described example in FIG. 6, a pipeline network to be analyzed by the analyzing device 100 including the estimation unit 220 or the analysis unit 130 is illustrated. In the examples, the pipeline networks to be analyzed are, for example, portions of a water supply network.

In the example illustrated in FIG. 9, measuring instruments 550-1 and 550-2 are installed on a pipeline 501-1. That is, in the example illustrated in FIG. 9, it is assumed that a measurement sector is set on the pipeline 501-1 and the analyzing device 200 performs analysis and the like with respect to the measurement sector. In addition, to the pipeline 501-1, a pipeline 501-2 is connected. A case is assumed where a leaking hole 505 is formed on the pipeline 501-2 and water leaks from the leaking hole 505.

In the example illustrated in FIG. 10, as with the example in FIG. 9, the measuring instruments 550-1 and 550-2 are installed on a pipeline 501-1. That is, in the example illustrated in FIG. 10, it is also assumed that a measurement sector is set on the pipeline 501-1 and the analyzing device 200 performs analysis and the like with respect to the measurement sector. In addition, to the pipeline 501-1, a pipeline 501-2 is connected. Further, to the pipeline 501-2, leading-in pipes 503-1 and 503-2 to houses 504-1 and 504-2, respectively, are connected. A case is assumed where water is respectively used in the houses 504-1 and 504-2.

In addition, in the coordinate system on the right side in each of FIGS. 9 and 10, relationships among time points at which pairs of vibration waveforms that were used when cross-correlation function were calculated were measured, locations on the pipeline corresponding to peaks in the cross-correlation function, and the magnitudes of the peaks in the cross-correlation function are illustrated.

In the coordinate system illustrated in each of FIGS. 9 and 10, the ordinate represents locations on the pipeline corresponding to peaks in cross-correlation function and the abscissa represents time points at which pairs of vibration waveforms that were used when the cross-correlation function were calculated were measured. Based on an arrival time difference of vibrations at which a cross-correlation function calculated during a period of a predetermined length from a point of time peaks, a location at which the detected vibrations are generated is obtained. When the magnitude of the peak in the cross-correlation function satisfies a predetermined condition, a mark is plotted at a position in the coordinate system corresponding to the location and the point of time.

In this case, when the magnitude of the peak in the cross-correlation function satisfies the predetermined condition and is further greater than a second threshold value, a filled circle mark is plotted. When the magnitude of the peak in the cross-correlation function, although satisfying the predetermined condition, is further smaller than the second threshold value, an unfilled circle mark is plotted. As will be described later, when estimating a cause of the detected vibrations based on variation in the magnitudes of peaks in cross-correlation function, the estimation unit 220 takes into consideration whether each peak in the cross-correlation function is greater than the second threshold value.

Further, in an upper-right area in FIG. 10, amplitudes of vibrations generated by use of water in the respective houses 504-1 and 504-2 are illustrated with respect to time points at which pairs of vibration waveforms are measured. It is illustrated that the amplitude of the vibration caused by use of water in the house 504-1 is smaller than the amplitude of the vibration caused by use of water in the house 504-2.

First, with regard to the example illustrated in FIG. 9, an example of estimation and the like mainly performed by the estimation unit 220 of the analyzing device 200 will be described. As described above, the leaking hole 505 is formed on the pipeline 501-2 and water leaks from the leaking hole 505. In this case, it is preferably required that an analysis result indicating that there is a possibility that leakage has occurred on the pipeline 501-2 is obtained by the analyzing device 200.

In this case, cross-correlation function for pairs of vibration waveforms measured by the measuring instruments 550-1 and 550-2 are calculated by the cross correlation calculation unit 110. The estimation unit 220 first estimates, for the cross-correlation function calculated with respect to the respective pairs of vibration waveforms during a plurality of consecutive periods of a predetermined length, respective locations at which the detected vibrations are generated based on peaks in the cross-correlation function. Obtained results are plotted as illustrated in the coordinate system on the right side in FIG. 9. That is, the above-described filled-circle marks are plotted at positions in the coordinate system corresponding to a point at which the pipelines 501-1 and 501-2 are connected to each other. In other words, the estimation unit 120 estimates that the point at which the pipelines 501-1 and 501-2 are connected to each other is a location at which the detected vibrations are generated.

Further, the estimation unit 120 estimates a cause of the detected vibrations based on continuity of peaks in the cross-correlation function. In the coordinate system on the right side in FIG. 9, filled circles are consecutively plotted at positions in the coordinate system corresponding to the point at which the pipelines 501-1 and 501-2 are connected to each other. That is, it is considered that the detected vibrations are generated continuously. It is also considered that the degree of variation in the magnitudes of the peaks in the cross-correlation function is small. Thus, the estimation unit 120 estimates that the detected vibrations are caused by leakage.

Next, with regard to the example illustrated in FIG. 10, an example of estimation and the like mainly performed by the estimation unit 220 of the analyzing device 200 will be described. As described above, water is used in the respective houses 504-1 and 504-2, which are connected to the pipeline 501-2 via the leading-in pipes 503-1 and 503-2, respectively. In this case, it is preferably required that an analysis result indicating that vibrations caused by use of water are generated at the connection point between the pipelines 501-1 and 501-2 is obtained by the analyzing device 200.

In this case, as with the example illustrated in FIG. 9, cross-correlation function between pairs of vibration waveforms measured by the measuring instruments 550-1 and 550-2 is calculated by the cross correlation calculation unit 110. The estimation unit 220 first estimates respective locations at which the detected vibrations are generated based on peaks in the cross-correlation function calculated with respect to the pairs of vibration waveforms during a plurality of consecutive periods of a predetermined length. The estimation unit 220 also discriminates whether the magnitudes of values of the cross-correlation function exceed the above-described second threshold value. Obtained results are plotted as illustrated in the coordinate system on the right side in FIG. 10. That is, the above-described filled-circle marks or unfilled circle marks are plotted at positions in the coordinate system corresponding to the point at which the pipelines 501-1 and 501-2 are connected to each other. In other words, the estimation unit 120 estimates that the point at which the pipelines 501-1 and 501-2 are connected to each other is a location at which the detected vibrations are generated.

The estimation unit 220 determines whether the magnitudes of the respective peaks in the cross-correlation function calculated for pairs of vibration waveforms during consecutive periods of the predetermined length satisfy a predetermined condition repeatedly. In the example illustrated in FIG. 10, since unfilled circle marks or filled circle marks are plotted consecutively in the coordinate system on the right side, it is determined that the magnitudes of the peaks satisfy the predetermined condition repeatedly.

Further, the estimation unit 220 also determines whether variation in the magnitudes of the respective peaks in the cross-correlation function exceeds a predetermined range. In the example illustrated in FIG. 10, the magnitudes of the respective peaks in the cross-correlation function are represented by both unfilled circle marks and filled circle marks.

In the example, peaks in cross-correlation function calculated based on pairs of vibration waveforms measured during periods of time during which water is used in the house 504-1 are represented by unfilled circle marks. In addition, peaks in cross-correlation function calculated based on pairs of vibration waveforms measured during periods of time during which water is used in the house 504-2 are represented by filled circle marks. That is, a difference is generated between the magnitudes of the peaks in the cross-correlation function according to a difference between amplitudes of vibrations respectively generated in the houses 504-1 and 504-2.

Consequently, in the example illustrated in FIG. 10, it is considered that the magnitudes of the peaks fluctuate around the above-described threshold value. Thus, the estimation unit 220 estimates that the detected vibrations are generated caused by a cause other than leakage. That is, the above-described desirable analysis result is obtained.

In the estimation unit 120 of the first example embodiment, variation in the magnitudes of peaks in cross-correlation function is not taken into consideration. Thus, in the example illustrated in FIG. 10, since the magnitudes of the peaks in the cross-correlation function satisfy a predetermined condition consecutively and repeatedly, the estimation unit 120 estimates that the detected vibrations are caused by leakage. That is, the estimation unit 120 has a possibility to erroneously discriminate a cause of vibrations in such a case.

On the other hand, in the present example embodiment, variation in the magnitudes of peaks in cross-correlation function is taken into consideration by the estimation unit 220. Thus, when vibrations are continuously generated on the pipelines by a plurality of causes other than leakage as illustrated in FIG. 10, the estimation unit 220 enables estimation that the detected vibrations are generated by a cause other than leakage. Therefore, the estimation unit 220 enables prevention of erroneous discrimination.

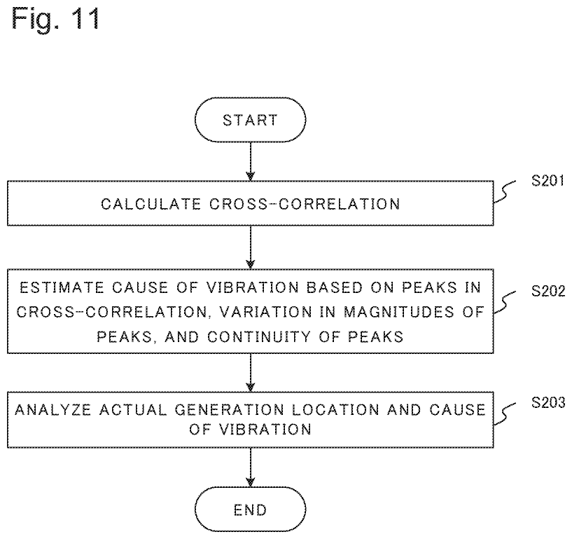

Next, with reference to a flowchart illustrated in FIG. 11, operation of the analyzing device 200 in the present example embodiment will be described. Note that a description of the same operation as that of the analyzing device 100 in the first example embodiment will be appropriately omitted.

First, the cross correlation calculation unit 110 calculates cross-correlation function with respect to pairs of vibration waveforms during periods of a predetermined length that were detected at a pair of points on a pipeline (step S201). Processing in step S201 is performed in a similar manner to the processing in step S101 in the first example embodiment.

Next, the estimation unit 220 estimates a generation location of the detected vibrations and a cause of the detected vibrations based on peaks in the cross-correlation function calculated in step S201, variation in the magnitudes of the peaks, and continuity of the peaks (step S202).

As an example in this case, the estimation unit 220 first estimates a location at which the detected vibrations are generated based on arrival time differences between the pairs of vibration waveforms at which the cross-correlation function for a plurality of pairs of consecutive vibration waveforms of the predetermined length, the cross-correlation function having been calculated in step S201, peak. The estimation of a generation location of the detected vibrations is performed in a similar manner to the processing in step S102 in the first example embodiment.

The estimation unit 220 determines whether the number of times that the magnitudes of the peaks in the cross-correlation function are consecutively determined to satisfy a predetermined condition exceeds a predetermined number of times. In addition, when the peaks satisfy the predetermined condition consecutively more than the predetermined number of times, the estimation unit 220 also determines whether variation in the magnitudes of the peaks exceeds a predetermined range. Based on these determination results, the estimation unit 220 estimates a cause of the detected vibrations.

Next, the analysis unit 130 analyzes an actual generation location and cause of the detected vibrations based on the generation location and cause of the detected vibrations estimated in step S202 and information on a configuration of a pipeline network (step S203).

As described thus far, in the analyzing device 200 in the second example embodiment of the present invention, the estimation unit 220 estimates a cause of the detected vibrations based on variation in the magnitudes of peaks in cross-correlation function in addition to continuity of the peaks. The configuration described above enables estimation that the detected vibrations are generated by a cause other than leakage when the vibration is continuously generated on the pipelines caused by a plurality of causes other than leakage. Therefore, the analyzing device 200 enables further prevention of erroneous discrimination.

### Third Example Embodiment

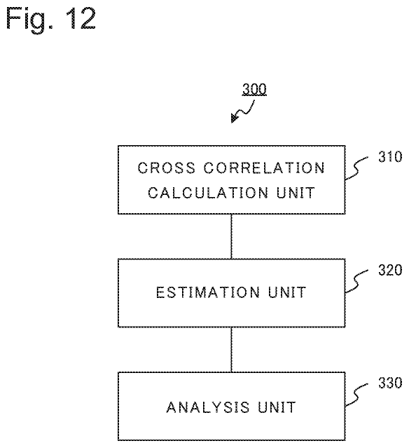

Next, a third example embodiment of the present invention will be described. FIG. 12 is a diagram illustrating an analyzing device in the third example embodiment of the present invention.

As illustrated in FIG. 12, an analyzing device 300 in the third example embodiment of the present invention includes a cross correlation calculation unit 310, an estimation unit 320, and an analysis unit 330. The cross correlation calculation unit 310 is configured to calculate cross-correlation function between vibrations detected at each of pairs of points contained in a plurality of measurement sectors. The estimation unit 320 is configured to estimate a generation location of the detected vibrations and a cause of the detected vibrations with respect to each of the plurality of measurement sectors based on peaks and continuity of the peaks in cross-correlation function in the one of the plurality of measurement sectors. The analysis unit 330 is configured to analyze an actual location at which the detected vibrations are generated and an actual cause of the detected vibrations based on generation locations and causes of the detected vibrations estimated based on peaks in cross-correlation function for the plurality of measurement sectors and information on a configuration of a pipeline network. Note that the estimation unit 320 may estimate a generation location and cause of the detected vibrations with respect to each of the plurality of measurement sectors, further based on variation in the magnitudes of peaks in cross-correlation function.

That is, the analyzing device 300 in the present example embodiment differs from the above-described analyzing devices 100 and 200 in that the respective constituent components perform analysis and the like based on a vibration detected in a plurality of measurement sectors and cross-correlation function for the detected vibrations.

As described above, a pipeline network, such as a water supply network, is generally constituted by a plurality of pipelines connected to each other. Therefore, a vibration generated at one place may be detected at a plurality of places on one pipeline or on a plurality of pipelines. It is considered that performing measurement and analysis of a vibration with respect to a plurality of measurement sectors enables determination of a generation location and cause of the detected vibrations with high precision. Thus, in the present example embodiment, the analyzing device 300 performs estimation and analysis of an actual generation location of the detected vibrations, an actual cause of the detected vibrations, and the like based on cross-correlation function for the detected vibrations detected in a plurality of measurement sectors.

Next, the respective constituent components of the analyzing device 300 in the present example embodiment will be described. Note that descriptions of constituent components that are similar to constituent components included in the analyzing device 100 in the first example embodiment or the analyzing device 200 in the second example embodiment will be appropriately omitted.

The cross correlation calculation unit 310 calculates cross-correlation function between vibrations detected at each of pairs of points contained in a plurality of measurement sectors of pipelines. The cross-correlation function is calculated with respect to each measurement sector in a similar manner to the calculation performed by the cross correlation calculation unit 110.

Note that the plurality of measurement sectors are, for example, set for the respective ones of a plurality of pipelines. Note, however, that a plurality of measurement sectors may be set for one pipeline. When, to a measurement sector on one pipeline, another pipeline is connected, as in the above-described example in FIG. 6 and the like, it is preferable that, to at least a portion of the another pipeline, another measurement sector be set.

The estimation unit 320 respectively estimates a generation location of the detected vibrations and a cause of the detected vibrations with respect to each one of the plurality of measurement sectors based on peaks and continuity of the peaks in cross-correlation function in the one of the plurality of measurement sectors.

The estimation unit 320, with respect to each of the plurality of measurement sectors, respectively estimates a generation location of the detected vibrations and a cause of the detected vibrations based on peaks and continuity of the peaks in cross-correlation function, as with, for example, the estimation unit 120. The estimation unit 320 may also estimate a cause of a vibration based on variation in the magnitudes of peaks, as with the estimation unit 220 in the second example embodiment.

The analysis unit 330 analyzes an actual generation location of the detected vibrations and an actual cause of the detected vibrations based on generation locations and causes of the detected vibrations respectively estimated based on peaks and continuity of the peaks in cross-correlation function for the plurality of measurement sectors and the information on the configuration of the pipeline network. The analysis unit 330, as with the above-described analysis unit 130, analyzes an actual location at which the detected vibrations are generated and an actual cause of the detected vibrations. The analysis unit 330 performs analysis on whether vibrations respectively detected in the plurality of measurement sectors are the same vibration.

In this case, the analysis unit 330 analyzes based on continuities of peaks in cross-correlation function calculated for vibrations that were detected in the respective ones of the plurality of measurement sectors and the information on the configuration of the pipeline network, whether the vibrations are the same vibration. In addition, there is a case where the estimation unit 320 estimates causes of vibrations based on variations in the magnitudes of peaks. In this case, the estimation unit 330 may analyze based on the variations in the magnitudes of the peaks in the cross-correlation function and the information on the configuration of the pipeline network, whether the vibrations detected in the respective ones of the plurality of measurement sectors are the same vibration.

As an example, a case is assumed where, with respect to a measurement sector, it is analyzed that there is a possibility that the detected vibrations are generated on another pipeline. The analysis unit 330 analyzes whether the detected vibrations are caused by the same cause based on peaks and continuity of the peaks in cross-correlation function in a measurement sector set to the another pipeline.

In the analysis unit 330, analysis on the possibility that the detected vibrations are generated on another pipeline is performed with respect to each of the measurement sectors in a similar manner to the analysis performed by the analysis unit 130. That is, when the information on the configuration of the pipeline network indicates that, at a generation location of the detected vibrations estimated by the estimation unit 320 with respect to a certain measurement sector, another pipeline is connected, it is analyzed that the detected vibrations are generated on the another pipeline.

When a measurement sector is also set to the another pipeline, the analysis unit 330 determines whether continuities of peaks in cross-correlation function in the respective ones of the certain measurement sector and the another measurement sector are the same. Whether continuities of peaks in cross-correlation function are the same is determined based on whether, when, for example, vibrations were measured during the same periods in the respective measurement sectors, the magnitudes of peaks coincide with each other in each period of a predetermined length during which the vibrations were measured. When continuities of peaks are the same, the analysis unit 330 analyzes that the vibrations detected in the respective measurement sectors are the same vibration.

In addition, when a difference among continuities of peaks in cross-correlation function with respect to the respective measurement sectors is within a predetermined range, the estimation unit 330 may analyze that there is a possibility that the detected vibrations detected in the respective measurement sectors are the same vibration. The predetermined range may only be appropriately determined according to various conditions, such as length of a pipeline and amplitude of a vibration in each measurement sector.

Further, there is a case where causes of vibrations have been estimated by the estimation unit 320 based on variations in the magnitudes of peaks in cross-correlation function. In this case, the analysis unit 330 may determine whether variations in the magnitudes of peaks in cross-correlation function in the respective ones of a certain measurement sector and another measurement sector are the same.

Whether variations in the magnitudes of peaks in cross-correlation function are the same is determined based on whether, when, for example, vibrations were measured during the same periods in the respective measurement sectors, the variations in the magnitudes of the peaks coincide with each other in each period of a predetermined length, which is a unit of measurement of vibration. When variations in the magnitudes of peaks in cross-correlation function in the respective ones of the certain measurement sector and the another measurement sector are the same, the estimation unit 330 analyzes that there is a possibility that the vibrations detected in the respective measurement sectors are the same vibration.

In addition, when a difference among variations in the magnitudes of peaks falls within a predetermined range, the analysis unit 330 may analyzes that there is a possibility that the vibrations detected in the respective measurement sectors are the same vibration. In this case, the predetermined range may only be appropriately determined according to various conditions.

In both cases, when continuities of peaks and the magnitudes of the peaks are different from each other, the analysis unit 330, for example, analyzes that the vibrations detected in the respective measurement sectors are different vibrations from each other. That is, the analysis unit 330 analyzes that the above-described vibrations detected in the respective ones of a certain measurement sector and another measurement sector are respectively separate vibrations generated at separate points.

When a vibration generated at a place in the pipeline network is measured in a plurality of measurement sectors, there is a possibility that it is analyzed that vibrations are generated at two places in the pipeline network. In addition, in this case, there is a possibility that an administrator or the like of the pipeline network who sees an analysis result interprets that vibrations are generated at two places in the pipeline network. The analysis unit 330 performs analysis on an actual generation location of a vibration and an actual cause of the detected vibrations, referring to the information on the configuration of the pipeline network, and therefore enables erroneous discrimination and the like as described above to be prevented.

Note that the estimation unit 330 may, by performing the above-described analysis with respect to three or more measurement sectors, analyze a possibility that vibrations detected in the respective measurement sectors are the same vibration.

Note that, in all cases, a vibration may be a vibration caused by leakage or a vibration caused by a cause other than leakage. The analysis unit 330 analyzes a cause of the detected vibrations in a similar manner to the analysis by the analysis unit 130.

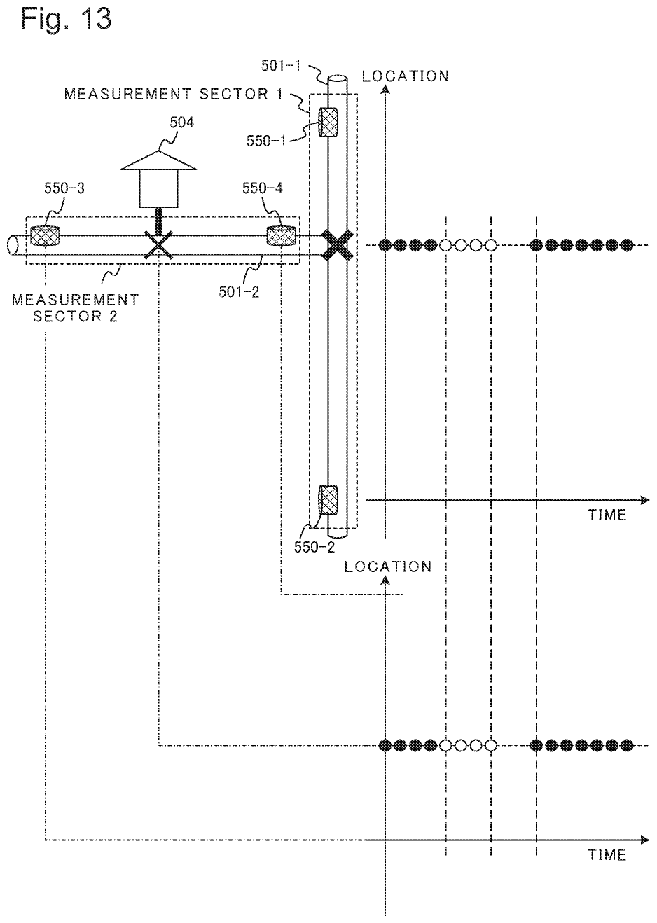

Analysis performed by the analysis unit 330 of the analyzing device 300 will be further described using a specific example illustrated in FIG. 13. FIG. 13 is a diagram illustrating an example of pipelines to be analyzed by the analyzing device 300.

On the left side in FIG. 13, as with the afore-described examples in FIGS. 6 and 9 and the like, a pipeline network to be analyzed by the analyzing device 300 including the estimation unit 320 or the analysis unit 330 is illustrated. In the example, the pipeline network to be analyzed is, for example, a portion of a water supply network.

In the example illustrated in FIG. 13, measuring instruments 550-1 and 550-2 are installed on a pipeline 501-1. That is, in the example illustrated in FIG. 13, a first measurement sector is set on the pipeline 501-1.

In addition, to the pipeline 501-1, a pipeline 501-2 is connected. A point at which the pipelines 501-1 and 501-2 are connected to each other is contained in the above-described first measurement sector. On the pipeline 501-2, measuring instruments 550-3 and 550-4 are installed. That is, a second measurement sector is set on the pipeline 501-2. In addition, to the pipeline 501-2, a leading-in pipe to a house 504 is connected. A case is assumed where water is used in the houses 504. Therefore, it is preferably required that an analysis result indicating that a vibration caused by use of water is generated at a point at which the leading-in pipe is connected to the pipeline 501-2 is obtained by the analyzing device 300.

In addition, in the coordinate systems on the right side in FIG. 13, relationships among time points at which pairs of vibration waveforms that were used when cross-correlation function were calculated were measured, locations on the pipelines corresponding to peaks in the cross-correlation function, and the magnitudes of the peaks in the cross-correlation function are illustrated. In the coordinate system in an upper-right area in FIG. 13, relationships in a measurement sector 1 are illustrated, and, in the coordinate system in a lower-right area in FIG. 13, relationships in a measurement sector 2 are illustrated.

As with the examples in FIGS. 9 and 10, in each coordinate system illustrated in FIG. 13, the ordinate represent locations on the pipeline corresponding to peaks in cross-correlation function and the abscissa represents time points at which pairs of vibration waveforms that were used when the cross-correlation function were calculated were measured. Based on an arrival time difference of a vibration at which a cross-correlation function calculated during a period of a predetermined length from a point of time peaks, a location at which the detected vibrations are generated is obtained. When the magnitude of the peak in the cross-correlation function satisfies a predetermined condition, a mark is plotted at a position in the coordinate system corresponding to the location and the point of time. Note that, in the example illustrated in FIG. 13, time points with respect to the measurement sectors 1 and 2 are synchronized with each other. That is, in the horizontal axis direction with respect to the measurement sectors 1 and 2, the same positions represent the same time points.

In addition, in each coordinate system illustrated in FIG. 13, as with the examples in FIGS. 9 and 10, when the magnitude of a peak in a cross-correlation function satisfies a predetermined condition and is further greater than a second threshold value, a filled circle mark is plotted. When the magnitude of a peak in a cross-correlation function, although satisfying the predetermined condition, is further smaller than the second threshold value, an unfilled circle mark is plotted.

In this case, first, cross-correlation function with respect to the measurement sector 1 are calculated. In addition, estimation of a generation location and cause of a vibration with respect to the measurement sector 1 is performed. By the cross correlation calculation unit 310, cross-correlation function for pairs of vibration waveforms measured by the measuring instruments 550-1 and 550-2 are calculated. The estimation unit 320 first estimates, for the cross-correlation function calculated with respect to the respective pairs of vibration waveforms during a plurality of consecutive periods of a predetermined length, respective locations at which the detected vibrations are generated based on peaks in the cross-correlation function. Obtained results are plotted as illustrated in the coordinate system in the upper-right area in FIG. 13. That is, the above-described filled-circle marks are plotted at positions in the coordinate system corresponding to a point at which the pipelines 501-1 and 501-2 are connected to each other. In other words, the estimation unit 320 estimates that the point at which the pipelines 501-1 and 501-2 are connected to each other is a location at which the detected vibrations are generated.

In addition, the estimation unit 320 determines whether or not the magnitudes of the respective peaks in the cross-correlation function calculated with respect to respective pairs of vibration waveforms during consecutive periods of the predetermined length satisfy a predetermined condition repeatedly.

In the example illustrated in the upper-right area in FIG. 13, since, although there exists a period of time during which the magnitudes of peaks of cross-correlation function do not satisfy the predetermined condition temporarily, filled circle marks or unfilled circle marks are plotted consecutively in the coordinate system, it is determined that the magnitudes of the peaks satisfy the predetermined condition repeatedly.

Further, the estimation unit 320 also determines whether or not variation in the magnitudes of the peaks in the cross-correlation function exceeds a predetermined range. In the example illustrated in the upper-right area in FIG. 13, the magnitudes of the respective peaks in the cross-correlation function are represented by both unfilled circle marks and filled circle marks. In addition, a period of time during which the magnitudes of peaks in cross-correlation function do not satisfy the predetermined condition is included. That is, it is considered that the magnitudes of the peaks fluctuate around the above-described second threshold value. Thus, the estimation unit 320 estimates that the measured vibration is generated caused by a cause other than leakage.

Next, cross-correlation function with respect to the measurement sector 2 are calculated. In addition, estimation of a generation location and cause of a vibration with respect to the measurement sector 2 is performed. By the cross correlation calculation unit 310, cross-correlation function for pairs of vibration waveforms measured by the measuring instruments 550-3 and 550-4 are calculated. The estimation unit 320 first estimates, for the cross-correlation function calculated with respect to the respective pairs of vibration waveforms during a plurality of consecutive periods of a predetermined length, respective locations at which the detected vibrations are generated based on peaks in the cross-correlation function. Obtained results are plotted as illustrated in the coordinate system in the lower-right area in FIG. 13.

That is, filled-circle marks as described above are plotted at positions in the coordinate system corresponding to a point at which the leading-in pipe to the house 504 is connected. In other words, the estimation unit 320 estimates that the point at which the leading-in pipe is connected is a location at which the detected vibrations are generated.

In addition, the estimation unit 320 determines whether or not the magnitudes of the respective peaks in the cross-correlation function for the measurement sector 2 calculated for respective pairs of vibration waveforms during consecutive periods of the predetermined length satisfy a predetermined condition repeatedly. In the example illustrated in the lower-right area in FIG. 13, since, although there exists a period of time during which the magnitudes of peaks of cross-correlation function do not satisfy the predetermined condition temporarily, filled circle marks or unfilled circle marks are plotted consecutively in the coordinate system, it is determined that the magnitudes of the peaks satisfy the predetermined condition repeatedly.

Further, the estimation unit 320 also determines whether or not variation in the magnitudes of the peaks in the cross-correlation function exceeds a predetermined range. In the example illustrated in the lower-right area in FIG. 13, the magnitudes of the respective peaks in the cross-correlation function are represented by both unfilled circle marks and filled circle marks. In addition, a period of time during which the magnitudes of peaks in cross-correlation function do not satisfy the predetermined condition is included. That is, it is considered that the magnitudes of the peaks fluctuate around the above-described second threshold value. Thus, the estimation unit 320 estimates that the measured vibration is generated caused by a cause other than leakage.

On such estimation results by the estimation unit 320, the analysis unit 330 performs analysis, referring to the information on the configuration of the pipeline network. As described above, at the generation location of a vibration estimated for the measurement sector 1, the pipeline 501-2 is connected. The analysis unit 330 thus analyzes that there is a possibility that the vibration detected in the measurement sector 1 is generated in the measurement sector 2.

In the example in FIG. 13, variations in the magnitudes of the respective peaks in the cross-correlation function coincide with each other. In more detail, in the coordinate systems in the upper-right area and the lower-right area in FIG. 13, periods of time during which the magnitudes of cross-correlation function are represented by filled circle marks or unfilled circle marks coincide with each other. In addition, in the coordinate systems in the upper-right area and the lower-right area in FIG. 13, periods of time during which the magnitudes of cross-correlation function do not satisfy the predetermined condition coincide with each other. Therefore, the analysis unit 330 analyzes that the vibrations are generated by the same cause.

Consequently, the analysis unit 330 analyzes that the detected vibrations are generated on the pipeline 501-2 by a cause other than leakage. That is, in the example illustrated in FIG. 13, the above-described desirable analysis result is obtained.

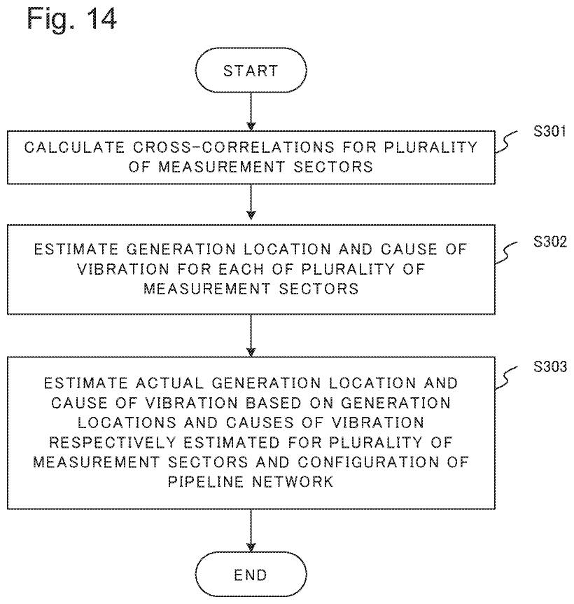

Next, with reference to a flowchart illustrated in FIG. 14, operation of the analyzing device 300 in the present example embodiment will be described. Note that a description of the same operation as that of the analyzing device 100 in the first example embodiment will be appropriately omitted.

First, the cross correlation calculation unit 310 calculates cross-correlation function with respect to pairs of vibration waveforms during periods of a predetermined length that were measured at respective pairs of points on pipelines contained in a plurality of measurement sectors (step S301). In step S301, the cross-correlation function with respect to the respective pairs of points on the pipelines contained in the plurality of measurement sectors may be calculated successively or in parallel.

Next, the estimation unit 320 estimates, with respect to each of the plurality of measurement sectors, a generation location of a vibration and a cause of the detected vibrations based on peaks and continuity of the peaks in the cross-correlation function calculated in step S301 (step S302). In step S302, the estimation unit 320 may further estimate a cause of the detected vibrations based on variation in the magnitudes of peaks.

Next, the analysis unit 330 analyzes an actual generation location and cause of a vibration based on the generation locations and causes of vibrations on the pipelines estimated with respect to the respective measurement sectors in step S302 and information on a configuration of a pipeline network (step S303). The analysis unit 330 performs, in addition to analysis similar to the above-described analysis performed by the analysis unit 130, analysis on whether or not vibrations respectively detected in the plurality of measurement sectors are the same vibration.

As described thus far, in the analyzing device 300 in the present example embodiment, the cross correlation calculation unit 310 and the estimation unit 320 respectively calculate cross-correlation function and perform estimation of generation locations and causes of vibrations with respect to a plurality of measurement sectors. The analysis unit 330 analyzes an actual generation location of a vibration and an actual cause of the detected vibrations based on the generation locations and causes of vibrations estimated with respect to the plurality of measurement sectors and information on a configuration of a pipeline network.

More specifically, the analysis unit 330 performs analysis on whether or not vibrations respectively detected in the plurality of measurement sectors are the same vibration. When vibrations are detected in the respective ones of the plurality of measurement sectors, performing such analysis enables an erroneous discrimination that the vibrations are generated by separate causes to be avoided. Therefore, the analyzing device 300 enables further prevention of erroneous discrimination.

The whole or part of the example embodiments disclosed above can be described as, but not limited to, the following supplementary notes.

(Supplementary Note 1)

An analyzing device includes:

cross correlation calculation means for calculating cross-correlation function between vibrations detected at a pair of points contained in a measurement sector of a pipeline;

estimation means for estimating a cause of the detected vibrations based on continuity of peaks in the cross-correlation function; and

analysis means for analyzing an actual generation location of the detected vibrations and an actual cause of the detected vibrations based on the estimated cause of the detected vibrations and information on a configuration of a pipeline network.

(Supplementary Note 2)

In the analyzing device according to the supplementary note 1,

the estimation means estimates the cause of the detected vibrations based on whether the number of continuance times of the peaks in the cross-correlation function having magnitudes that satisfies a predetermined condition is more than a predetermined number of times.

(Supplementary Note 3)

In the analyzing device according to the supplementary note 1 or 2,

when the number of continuance times of the peaks in the cross-correlation function having magnitudes that satisfies a predetermined condition is more than a predetermined number of times, the estimation means estimates that the vibrations are caused by leakage.

(Supplementary Note 4)

In the analyzing device according to any one of the supplementary notes 1 to 3,

when the number of continuance times of the peaks in the cross-correlation function having magnitudes that satisfies a predetermined condition is not more than a predetermined number of times, the estimation means estimates that the vibrations are caused by a cause other than leakage.

(Supplementary Note 5)

In the analyzing device according to any one of the supplementary notes 1 to 4,

the analysis means analyzes the actual generation location of the detected vibrations and the actual cause of the detected vibrations based on information on a connection relationship with respect to the pipeline including the generation location of the detected vibrations estimated based on peaks in the cross-correlation function.

(Supplementary Note 6)

In the analyzing device according to the supplementary note 5,

when another pipeline is connected with the pipeline at the estimated generation location of the detected vibrations, the analysis means analyzes that there is a possibility that the actual generation location of the detected vibrations is located on the another pipeline.

(Supplementary Note 7)

In the analyzing device according to any one of the supplementary notes 1 to 6,

the estimation means estimates a cause of the detected vibrations based on variation in magnitudes of peaks in the cross-correlation function.

(Supplementary Note 8)

In the analyzing device according to any one of the supplementary notes 1 to 7,

when variation in magnitudes of peaks in the cross-correlation function exceeds a predetermined range, the estimation means estimates that the vibrations are caused by a cause other than leakage.

(Supplementary Note 9)

In the analyzing device according to any one of the supplementary notes 1 to 8,

when variation in magnitudes of peaks in the cross-correlation function does not exceed a predetermined range, the estimation means estimates that the vibrations are caused by leakage.

(Supplementary Note 10)

In the analyzing device according to any one of the supplementary notes 1 to 9,

the cross correlation calculation means calculates, for each of a plurality of measurement sectors, the cross-correlation function between the vibrations detected at the pair of points contained in the measurement sector of the pipeline,

the estimation means estimates, for each of the plurality of measurement sectors, the generation location of the detected vibrations and the cause of the detected vibrations based on the peaks and the continuity of the peaks in the cross-correlation function in each of the plurality of measurement sectors, and

the analysis means analyzes the actual generation location of the detected vibrations and the actual cause of the detected vibrations based on generation locations and causes of the detected vibrations estimated based on the peaks in the cross-correlation function for the plurality of measurement sectors and information on the configuration of the pipeline network.

(Supplementary Note 11)

In the analyzing device according to the supplementary note 10,

the analysis means analyzes whether vibrations respectively detected in the plurality of measurement sectors are the same vibration based on the continuity of peaks and variation in magnitudes of the peaks in the cross-correlation function in each of the plurality of measurement sectors.

(Supplementary Note 12)

In the analyzing device according to the supplementary note 11,

when a difference among continuities of peaks in a plurality of cross-correlation functions with respect to the plurality of measurement sectors falls within a predetermined range, the analysis means analyzes that the vibrations are the same vibration.

(Supplementary Note 13)

An analyzing device includes:

cross correlation calculation means for calculating cross-correlation function between vibrations detected at a pair of points contained in a measurement sector of a pipeline;

estimation means for estimating a generation location of the detected vibrations based on a peak in the cross-correlation function; and

analysis means for analyzing an actual generation location of the detected vibrations based on information on a connection relationship with respect to the pipeline including the estimated generation location of the detected vibrations.

(Supplementary Note 14)

In the analyzing device according to the supplementary note 13,

when another pipeline is connected with the pipeline at the estimated generation location of the detected vibrations, the analysis means analyzes that there is a possibility that the actual generation location of the detected vibrations is located on the another pipeline.

(Supplementary Note 15)

An analysis method includes:

calculating cross-correlation function between vibrations detected at a pair of points contained in a measurement sector of a pipeline;

estimating a cause of the detected vibrations based on continuity of peaks in the cross-correlation function; and

analyzing an actual generation location of the detected vibrations and an actual cause of the detected vibrations based on the estimated cause of the detected vibrations and information on a configuration of a pipeline network.

(Supplementary Note 16)

In the analysis method according to the supplementary note 15,

the cause of the detected vibrations is estimated based on whether the number of continuance times of the peaks in the cross-correlation function having magnitudes that satisfies a predetermined condition is more than a predetermined number of times.

(Supplementary Note 17)

In the analysis method according to the supplementary note 15 or 16,

the cause of the detected vibrations is estimated based on variation in magnitudes of peaks in the cross-correlation function.

(Supplementary Note 18)

The analysis method according to any one of the supplementary notes 15 to 17 further includes:

calculating, for each of a plurality of measurement sectors, the cross-correlation function between the vibrations detected at the pair of points contained in the measurement sector of the pipeline;

estimating, for each of the plurality of measurement sectors, the generation location of the detected vibrations and the cause of the detected vibrations based on the peaks and the continuity of the peaks in the cross-correlation function in each of the plurality of measurement sectors; and

analyzing the actual generation location of the detected vibrations and the actual cause of the detected vibrations based on generation locations and causes of the detected vibrations estimated based on the peaks in the cross-correlation function for the plurality of measurement sectors and information on the configuration of the pipeline network.

(Supplementary Note 19)

An analysis method includes:

calculating cross-correlation function between vibrations detected at a pair of points contained in a measurement sector of a pipeline;

estimating a generation location of the detected vibrations based on a peak in the cross-correlation function; and

analyzing an actual generation location of the detected vibrations based on information on a connection relationship with respect to the pipeline including the estimated generation location of the detected vibrations.

(Supplementary Note 20)

A computer-readable storage medium stores a program that causes a computer to perform:

calculating cross-correlation function between vibrations detected at a pair of points contained in a measurement sector of a pipeline;

estimating a cause of the detected vibrations based on continuity of peaks in the cross-correlation function; and

analyzing an actual generation location of the detected vibrations and an actual cause of the detected vibrations based on the estimated cause of the detected vibrations and information on a configuration of a pipeline network.

(Supplementary Note 21)

In the storage medium according to the supplementary note 20,

the program causes the computer to perform

estimating the cause of the detected vibrations based on whether the number of continuance times of the peaks in the cross-correlation function having magnitudes that satisfies a predetermined condition is more than a predetermined number of times.

(Supplementary Note 22)

In the storage medium according to the supplementary note 20 or 21,

the program causes the computer to perform

estimating the cause of the detected vibrations based on variation in magnitudes of peaks in the cross-correlation function.

(Supplementary Note 23)

In the storage medium according to any one of the supplementary notes 20 to 22,

the program causes the computer to further perform

calculating, for each of a plurality of measurement sectors, the cross-correlation function between the vibrations detected at the pair of points contained in the measurement sector of the pipeline;

estimating, for each of the plurality of measurement sectors, the generation location of the detected vibrations and the cause of the detected vibrations based on the peaks and the continuity of the peaks in the cross-correlation function in each of the plurality of measurement sectors; and

analyzing the actual generation location of the detected vibrations and the actual cause of the detected vibrations based on generation locations and causes of the detected vibrations estimated based on the peaks in the cross-correlation function for the plurality of measurement sectors and information on the configuration of the pipeline network.

(Supplementary Note 24)

A computer-readable storage medium stores a program that causes a computer to perform:

calculating cross-correlation function between vibrations detected at a pair of points contained in a measurement sector of a pipeline;

estimating a generation location of the detected vibrations based on a peak in the cross-correlation function; and

analyzing an actual generation location of the detected vibrations based on information on a connection relationship with respect to the pipeline including the estimated generation location of the detected vibrations.

The present invention was described above through example embodiments thereof, but the present invention is not limited to the above example embodiments. Various modifications that could be understood by a person skilled in the art may be applied to the configurations and details of the present invention within the scope of the present invention. In addition, configurations in the respective example embodiments can be combined with one another without departing from the scope of the present invention.

This application is based upon and claims the benefit of priority from Japanese patent application No. 2017-144431 filed on Jul. 26, 2017, the disclosure of which is incorporated herein in its entirety by reference.

### REFERENCE SIGNS LIST

100 Analyzing device

110, 310 Cross correlation calculation unit

120, 220, 320 Estimation unit

130, 330 Analysis unit

501 Pipeline

502 Valve plug

503 Leading-in pipe

504 House

550 Measuring instrument

1. An analyzing device comprising:
at least one processor configured to:
calculate cross-correlation function between vibrations detected at a pair of points contained in a measurement sector of a pipeline;
estimate a cause of the detected vibrations based on continuity of peaks in the cross-correlation function; and
analyze an actual generation location of the detected vibrations and an actual cause of the detected vibrations based on the estimated cause of the detected vibrations and information on a configuration of a pipeline network.

2. The analyzing device according to claim 1, wherein
the at least one processor estimates the cause of the detected vibrations based on whether the number of continuance times of the peaks in the cross-correlation function having magnitudes that satisfies a predetermined condition is more than a predetermined number of times.

3. The analyzing device according to claim 1, wherein
when the number of continuance times of the peaks in the cross-correlation function having magnitudes that satisfies a predetermined condition is more than a predetermined number of times, the at least one processor estimates that the vibrations are caused by leakage.

4. The analyzing device according to claim 1, wherein
when the number of continuance times of the peaks in the cross-correlation function having magnitudes that satisfies a predetermined condition is not more than a predetermined number of times, the at least one processor estimates that the vibrations are caused by a cause other than leakage.

5. The analyzing device according to claim 1, wherein
The at least one processor analyzes the actual generation location of the detected vibrations and the actual cause of the detected vibrations based on information on a connection relationship with respect to the pipeline including the generation location of the detected vibrations estimated based on peaks in the cross-correlation function.

6. The analyzing device according to claim 5, wherein
when another pipeline is connected with the pipeline at the estimated generation location of the detected vibrations, the at least one processor analyzes that there is a possibility that the actual generation location of the detected vibrations is located on the another pipeline.

7. The analyzing device according to claim 1, wherein
the at least one processor estimates a cause of the detected vibrations based on variation in magnitudes of peaks in the cross-correlation function.

8. The analyzing device according to claim 1, wherein
when variation in magnitudes of peaks in the cross-correlation function exceeds a predetermined range, the at least one processor estimates that the vibrations are caused by a cause other than leakage.

9. The analyzing device according to claim 1, wherein
when variation in magnitudes of peaks in the cross-correlation function does not exceed a predetermined range, the at least one processor estimates that the vibrations are caused by leakage.

10. The analyzing device according to claim 1, wherein
the at least one processor calculates, for each of a plurality of measurement sectors, the cross-correlation function between the vibrations detected at the pair of points contained in the measurement sector of the pipeline,
estimates, for each of the plurality of measurement sectors, the generation location of the detected vibrations and the cause of the detected vibrations based on the peaks and the continuity of the peaks in the cross-correlation function in each of the plurality of measurement sectors, and
analyzes the actual generation location of the detected vibrations and the actual cause of the detected vibrations based on generation locations and causes of the detected vibrations estimated based on the peaks in the cross-correlation function for the plurality of measurement sectors and information on the configuration of the pipeline network.

11. The analyzing device according to claim 10, wherein
the at least one processor analyzes whether vibrations respectively detected in the plurality of measurement sectors are the same vibration based on the continuity of peaks and variation in magnitudes of the peaks in the cross-correlation function in each of the plurality of measurement sectors.

12. The analyzing device according to claim 11, wherein
when a difference among continuities of peaks in a plurality of cross-correlation functions with respect to the plurality of measurement sectors falls within a predetermined range, the at least one processor analyzes that the vibrations are the same vibration.

13-14. (canceled)

15. An analysis method comprising:
by at least one processor,
calculating cross-correlation function between vibrations detected at a pair of points contained in a measurement sector of a pipeline;
estimating a cause of the detected vibrations based on continuity of peaks in the cross-correlation function; and
analyzing an actual generation location of the detected vibrations and an actual cause of the detected vibrations based on the estimated cause of the detected vibrations and information on a configuration of a pipeline network.

16. The analysis method according to claim 15, wherein
the cause of the detected vibrations is estimated based on whether the number of continuance times of the peaks in the cross-correlation function having magnitudes that satisfies a predetermined condition is more than a predetermined number of times.

17. The analysis method according to claim 15, wherein
the cause of the detected vibrations is estimated based on variation in magnitudes of peaks in the cross-correlation function.

18. The analysis method according to claim 15 further comprising:
by the at least one processor,
calculating, for each of a plurality of measurement sectors, the cross-correlation function between the vibrations detected at the pair of points contained in the measurement sector of the pipeline;
estimating, for each of the plurality of measurement sectors, the generation location of the detected vibrations and the cause of the detected vibrations based on the peaks and the continuity of the peaks in the cross-correlation function in each of the plurality of measurement sectors; and
analyzing the actual generation location of the detected vibrations and the actual cause of the detected vibrations based on generation locations and causes of the detected vibrations estimated based on the peaks in the cross-correlation function for the plurality of measurement sectors and information on the configuration of the pipeline network.

19. (canceled)

20. A non-transitory computer-readable storage medium storing a program causing a computer to perform:
calculating cross-correlation function between vibrations detected at a pair of points contained in a measurement sector of a pipeline;
estimating a cause of the detected vibrations based on continuity of peaks in the cross-correlation function; and
analyzing an actual generation location of the detected vibrations and an actual cause of the detected vibrations based on the estimated cause of the detected vibrations and information on a configuration of a pipeline network.

21. The non-transitory storage medium according to claim 20, wherein
the program causes the computer to perform
estimating the cause of the detected vibrations based on whether the number of continuance times of the peaks in the cross-correlation function having magnitudes that satisfies a predetermined condition is more than a predetermined number of times.

22. The non-transitory storage medium according to claim 20, wherein
the program causes the computer to perform
estimating the cause of the detected vibrations based on variation in magnitudes of peaks in the cross-correlation function.

23. The non-transitory storage medium according to claim 20, wherein
the program causes the computer to further perform
calculating, for each of a plurality of measurement sectors, the cross-correlation function between the vibrations detected at the pair of points contained in the measurement sector of the pipeline;
estimating, for each of the plurality of measurement sectors, the generation location of the detected vibrations and the cause of the detected vibrations based on the peaks and the continuity of the peaks in the cross-correlation function in each of the plurality of measurement sectors; and
analyzing the actual generation location of the detected vibrations and the actual cause of the detected vibrations based on generation locations and causes of the detected vibrations estimated based on the peaks in the cross-correlation function for the plurality of measurement sectors and information on the configuration of the pipeline network.

24. (canceled)
